(19) United States
(12) Patent Application Publication
(10) Pub. No.: US 2024/0163000 A1
(43) Pub. Date: May 16, 2024

(54) DEVICES AND METHODS FOR ENHANCED TIME SYNCHRONIZATION

(71) Applicant: Intel Corporation, Santa Clara, CA (US)

(72) Inventors: Anshu AGARWAL, Bangalore (IN); Chandrashekar GOWDA, Bangalore (IN); Barath C. PETIT, Bangalore (IN); Suranjan CHAKRABORTY, Bangalore (IN); Naveen MANOHAR, Bangalore (IN); Amit Singh CHANDEL, Bhoganhalli (IN); Mythili HEGDE, Bangalore (IN)

(21) Appl. No.: 17/985,949

(22) Filed: Nov. 14, 2022

(51) Int. Cl. H04J 3/06; H04W 56/00

(52) U.S. Cl. CPC H04J 3/0667; H04W 56/0015

(57) ABSTRACT

The present disclosure relates to a device including a processor configured to: detect a failed reception of time synchronization information at a follower device, wherein the time synchronization information provides an update of a clock of the follower device for synchronization to a clock of a leader device; determine whether a clock drift between the clock of the follower device and the clock of the leader device is less than a predefined drift threshold; and in the case that the clock drift is less than the predefined drift threshold, instruct an update of the clock of the follower device based on time synchronization information previously received at the follower device.

### TECHNICAL FIELD

The present disclosure relates generally to devices, systems, and methods to provide enhanced time synchronization, for example for Time-Sensitive Networking (TSN) applications.

### BACKGROUND

In general, various technologies and standards have been developed for wired and wireless communication networks to take into consideration the peculiar requirements of different types of services and applications. For many applications, for example in Internet of Things (IoT) or Industrial Internet of Things (IIoT) environments, time-synchronization plays an important role in ensuring a correct operation of the devices participating in the network. As an example, time-synchronization may be relevant for coordinating the execution of a task among a plurality of actuators (e.g., a plurality of robots). As another example, time-synchronization may be relevant for distributed data acquisition, in which a sequence of events sensed by different sensors is temporally reconstructed after the measurements. As a further example, time-synchronization may be relevant for streaming services, in which audio and video content is reproduced. The development of advanced strategies for wired and/or wireless communication, and in particular for ensuring or maintaining time-synchronization within a network, is thus of fundamental importance for a variety of applications and services.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1A shows an exemplary communication network in a schematic representation according to the present disclosure;

FIG. 1B shows an exemplary communication flow for synchronizing the clock of a follower device to the clock of a leader device in a schematic representation according to the present disclosure;

FIG. 1C shows an exemplary communication device in a schematic representation according to the present disclosure;

FIG. 2 shows an exemplary network manager in a schematic representation according to the present disclosure;

FIG. 3A and FIG. 3B illustrate an exemplary detection of a failed reception of time synchronization information at a clock of a follower device;

FIG. 4 shows an exemplary determination of whether a drift of a follower clock with respect to a leader clock is less than a predefined drift threshold, in a schematic representation according to the present disclosure;

FIG. 5 shows an exemplary update of the clock of the follower device, in a schematic representation according to the present disclosure;

FIG. 6 shows an exemplary instructing of an update of the follower clock during a self-synchronization interval, in a schematic representation according to the present disclosure;

FIG. 7 shows an exemplary processing of information at the follower device, in a schematic representation according to the present disclosure;

FIG. 8 shows an exemplary communication network including a grandmaster clock and an ordinary clock, in a schematic representation according to the present disclosure;

FIG. 9 shows an exemplary flow diagram of a method of operating a communication network according to the present disclosure; and

FIG. 10 shows an exemplary flow diagram of a method of operating a back-off timer according to the present disclosure.

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects may be combined with one or more other aspects to form new aspects. Various aspects are described in connection with methods and various aspects are described in connection with devices (e.g., a device for use in a communication network, a network manager, etc.). However, it may be understood that aspects described in connection with methods may similarly apply to the devices, and vice versa.

With the increasing adoption of automated solutions in professional and consumer settings, there is a growing demand for technologies that ensure a stable, reliable, and fast communication. In particular, there is a growing interest in so-called “real-time” systems, in which the correct operation of the system is related not only to the logical result, but also to the timing of the result. In general a “real-time” system may refer to a scenario in which data are delivered to a plurality of destinations, so that the data will reach the different destinations at different times (e.g., due to different buffering conditions, different logic, etc.), but the output are to be provided in synchronization with one another (illustratively, in unison) to ensure a correct functioning of the system.

An example of “real-time” system may be a vehicle capable of autonomous or partially autonomous driving, where several sensors (e.g., LIDAR, radar, etc.) gather an understanding of a scene to allow a control unit of a vehicle to take informed decisions related to a driving action (e.g., steering the direction of the vehicle, stopping the vehicle, increasing the speed, and the like). As another example, in a factory several automated machines (e.g., industrial robots) may cooperate to carry out a complex task, where each automated machine may be assigned to a simpler subtask, such as moving an object, tightening a screw, exerting a torque, and the like. As a further example, in audio or video streaming applications, a synchronization among the output sources ensures that the audio and video are reproduced correctly.

In general, in a system that relies on time-critical information, one device may assume the role of grandmaster (GM) clock. The grandmaster clock may be a reference clock to which the clocks of the other devices present in the system are synchronized. The grandmaster clock may thus deliver time synchronization information to other clocks within the system, to allow the devices to have a common understanding of time and coordinate their operation. The other devices within the system may periodically receive time synchronization information and may adjust their respective clock to synchronize their clock with the grandmaster clock.

Application scenarios that rely on time-critical delivery of information are however vulnerable to a loss of synchronization among the devices, which may cause a malfunction of the system or the interruption of a process. If there is a loss of time synchronization information (e.g., a loss of time synchronization data packets), a device may stop processing time-critical information, since the correctness of the end-result may not be ensured, and will eventually experience a connection loss. On re-establishing the session, time sync is initiated again, leading to computation power loss and to losing time-critical information. Furthermore, the re-establishing of the session may cause a delay that could lead to a complete system failure, e.g. in case a certain time-critical operation is not carried out in time due to the connection loss.

The present disclosure is related to a strategy for maintaining operational continuity in a communication network even in the case that a loss of time synchronization information has occurred. According to the approach described herein, a device may determine whether the device may continue processing time-critical information by independently updating its own clock without relying on the (missing) time synchronization information. Illustratively, the strategy described herein may be based on the realization that it may be not necessary to immediately interrupt the processing of time-critical information in absence of time synchronization information (e.g., from a grandmaster clock), but it may rather be possible for a device to continue operating by deciding how to update its own clock based on historical data.

The strategy described herein provides thus an enhanced operation of a system (e.g., a communication network) in which time synchronization among the devices is relevant for the correct operation of the system. The strategy described herein may avoid the computation power loss where time synchronization is re-initiated during the re-establishment. Furthermore, the processing of time-critical information will proceed, so that a smooth operation of the system may be ensured (e.g., a task may be completed, audio may be reproduced, etc.). A configuration as described herein may thus be particularly suitable, without limitations, for low-latency applications, such as in control loops, medical applications, automated driving, and the like.

According to the present disclosure, a device may include a processor configured to: detect a failed reception of time synchronization information at a follower device (e.g., at a clock of the follower device, such as at a system clock of the follower device), the time synchronization information providing an update of a clock signal of the follower device for synchronization to a clock signal of a leader device; determine, upon detecting the failed reception of the time synchronization information, whether a clock drift between the clock signal of the follower device and the clock signal of the leader device is less than a predefined drift threshold; and in the case that the clock drift is less than the predefined drift threshold, instruct an update of the clock signal of the follower device based on time synchronization information previously received at the follower device.

According to the present disclosure, a device may include a processor configured to: determine if a time synchronization at a follower device fails, the time synchronization causing an update of a clock value of a clock of the follower device for synchronization to a further clock of another device; if it is determined that the time synchronization fails, determine whether a drift between the clock and the further clock is less than a predefined drift threshold; and if it is determined that the drift is less than the predefined drift threshold, update the clock value of the clock using time synchronization information previously received at the follower device.

According to the present disclosure, a device may include a processor configured to: instruct an update of a clock of a follower device to continue processing time-critical control information at the follower device in absence of time synchronization information from a leader device by using time synchronization information previously received at the follower device.

The strategy described herein may be applied in any suitable time-critical scenario, e.g. in any suitable communication network in which a time synchronization among the devices may influence the correct operation of the network. The most relevant use case for the configuration described herein may be in the context of Time-Sensitive Networking (TSN) applications, discussed in further detail below. Therefore, some of the terminology used in the present disclosure may pertain to the context of communication networks and devices configured according to the TSN-standard. It is however understood that the aspects described in relation to a TSN-scenario may apply in a corresponding manner to networks and/or devices configured according to other communication standards or protocols.

In an exemplary configuration, the decision on whether a (follower) device may continue processing time-critical information may be based on a plurality of previous clock drifts between the clock signal of the follower device and the clock signal of the leader device. Illustratively, the decision may be based on historical information representing how out of sync the follower device may be (or may have been) with respect to the leader device. An evaluation of the previous clock drifts may thus provide an accurate, yet simple measure of how reliably (and safely) the follower device may continue to operate in absence of the time synchronization information.

In an exemplary configuration, a back-off timer may be set to define a time interval during which the follower device may continue to operate in absence of the time synchronization information from the leader device. The starting value of the back-off timer may be dynamically adapted to adjust a period of time during which a reliable operation of the system may be ensured even in case of failed delivery of time synchronization information. The dynamic adaptation of the starting value of the back-off may thus provide a flexible management of the network that ensures a safe operation taking into account a network scenario.

The term “leader” may be used herein in relation to an entity, e.g. a device, a clock, etc. to describe that the entity may have or may assume a leader role with respect to one or more subordinate entities (e.g., one or more follower devices, one or more follower clocks, etc.). Illustratively, the term “leader” may be used to describe that an entity has a superordinate status and may lead the interaction with the one or more subordinate entities. The term “leader” may thus describe that the entity may establish or define one or more parameters to which the one or more subordinate entities may adapt (illustratively, the subordinate entities may follow the parameters that the “leader” defines).

The term “follower” may be used herein in relation to an entity, e.g. a device, a clock, etc. to describe that the entity may have or may assume a follower role with respect to one (or more) superordinate entity (e.g., one or more leader devices, one or more leader clocks, etc.). Illustratively, the term “follower” may be used to describe that an entity has a subordinate status and may adapt its operation according to information that the superordinate entity provides. The term “follower” may thus describe that the entity may receive one or more parameters according to which the follower entity may adapt its operation.

Depending on the technical context, in the present disclosure the terms “primary” and “secondary”, or “master” and “slave” may be used in a same manner as the terms “leader” and “follower”, respectively.

The term “clock” may be used in the present disclosure according to the common understanding of the term in the context of circuits and signal processing. Illustratively, a “clock” may be a source of timing information in a device, and the device may use the timing information provided by the “clock” to carry out its operation (e.g., for scheduling when an action should be taken, for defining a repetition rate of the action, and the like). A “clock” may represent a time of day with a predefined resolution (e.g., with millisecond resolution, microsecond resolution, nanosecond resolution, etc.), which may be adapted according to the desired application. A “clock” may represent the time of day in any suitable format, e.g. in terms of hours, minutes, and seconds, for example, or as an absolute number, or in binary format, or in any other format suitable for indicating the time of day. A “clock” may include, for example, an oscillator (such as a crystal oscillator) to measure the passing of time. Illustratively, the rate (or frequency) of oscillation may define the passing of time. In various aspects, a “clock” may be a “real-time clock”.

The term “clock generator” may be used in the present disclosure according to the common understanding of the term in the context of circuits and signal processing. Illustratively, a “clock generator” may be a source of an oscillating signal to drive the operation of a device, e.g. of a circuit (e.g., an analog or digital circuit). The oscillating signal may oscillate between a high state and a low state. As an example, an oscillating signal may be a square wave. In general, a “clock” may include a “clock generator”, or may be configured to function as “clock generator”, e.g. to output the oscillating signal for driving the operation of a device. The output of a “clock generator” may be referred to herein as “clock signal”. In general, a “clock signal” may have a rate (referred to herein as “clock rate”) and a phase (referred to herein as “clock phase”). The “clock rate” may represent the frequency at which the “clock signal” oscillates. The “clock phase” may represent the phase of the waveform of the clock signal.

The term “clock value” may be used in the present disclosure to describe a value of the time of day of a clock. Illustratively, a “clock value” may be or represent the (actual) time of day as indicated by the clock. A “clock value” may be represented in any suitable format, e.g. for processing by a device (e.g., for processing by a circuit).

The term “time synchronization” may be used herein to describe a state in which two clocks agree on the same time. Illustratively, a clock being synchronized (e.g., time synchronized) with another clock may describe that the two clocks indicate the same time (expressed in any suitable units), and also proceed at a same rate. Further illustratively, a time synchronization between two clocks may indicate that the two clocks have one or more of a same clock value, a same clock rate, and/or a same clock phase. Depending on the application scenario, one or more of clock value, clock rate, and/or clock phase may be synchronized to carry out a predefined (e.g., time-critical) operation. As an example, “time synchronization” may describe a phase-locking between two clocks, so that time increments in the two clocks occur at the same rate and at the same time.

The term “time-critical” may be used herein to describe information (e.g., instructions, sensor data, etc.) for which the timing of the processing of the information influences the correctness of an operation (illustratively, a time-critical operation) associated with the information. As an example, “time-critical” information may include instructions for executing a task at a certain time point, or in a certain sequence. As another example, “time-critical” information may include audio data or video data to be reproduced with a certain timing, e.g. in synchronization over two speakers, in synchronization between audio and video, etc.

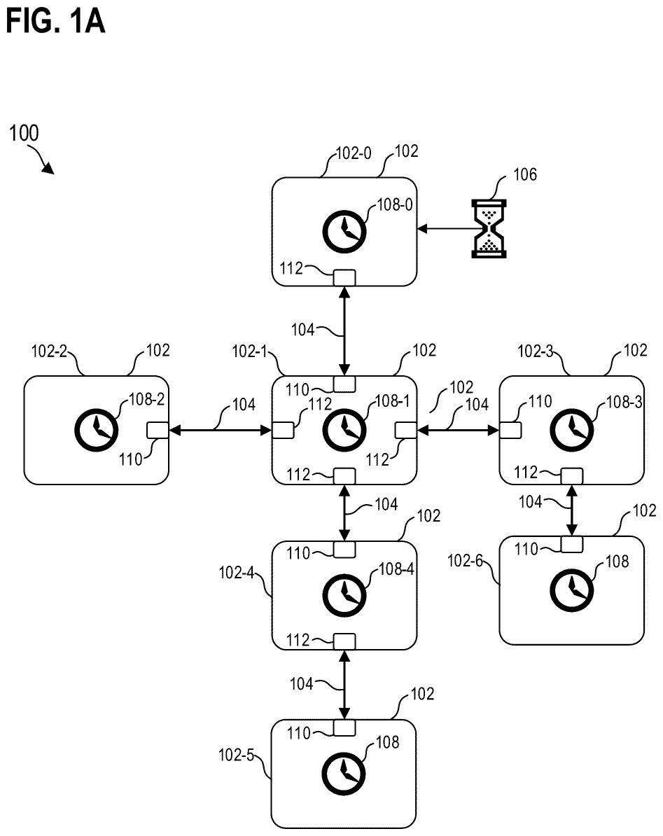

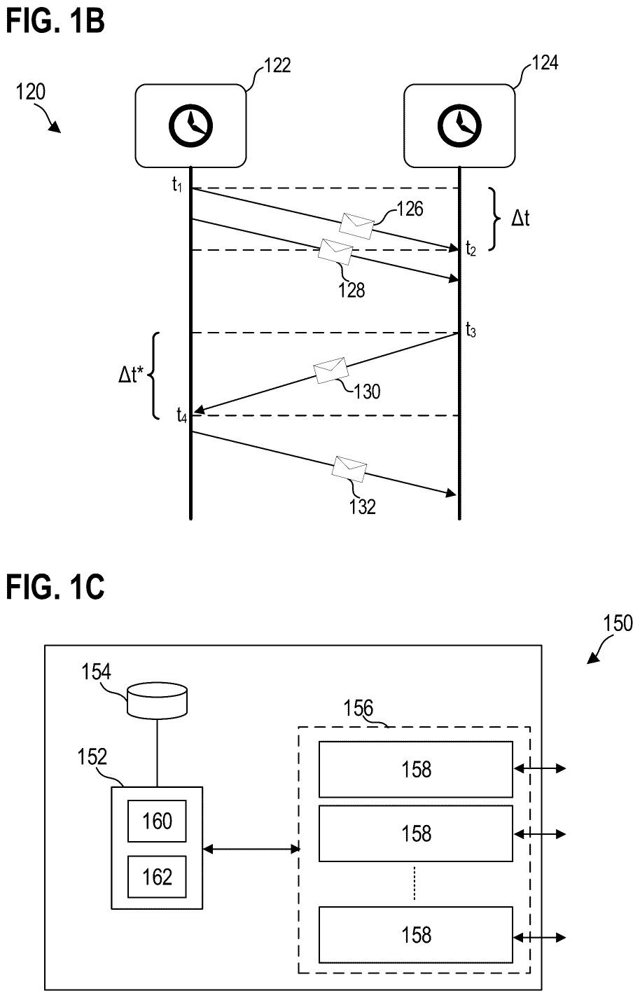

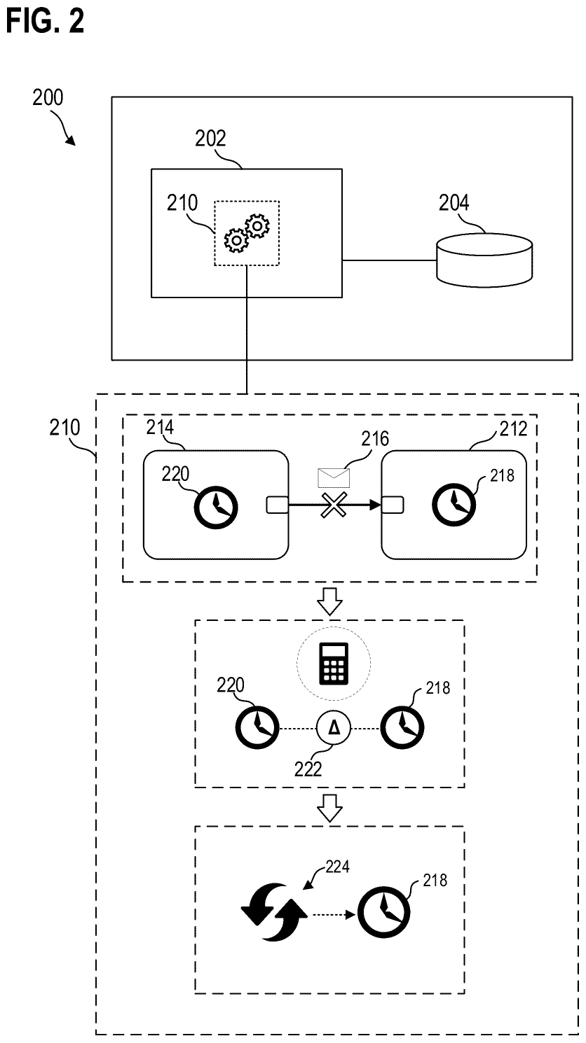

FIG. 1A shows a communication network 100 in a schematic representation according to the present disclosure. FIG. 1A illustrates an exemplary scenario in which the strategy described herein may be implemented (discussed in further detail in relation to FIG. 2 to FIG. 10). It is understood that the representation of the communication network 100 is exemplary and that a communication network 100 may have any suitable configuration, e.g. a different number of networked devices 102, different communicative coupling among the networked devices 102, etc. The communication network 100 may also be referred to simply as network 100.

The communication network 100 may include a plurality of devices 102 communicatively coupled with one another. A device 102 may be communicatively coupled with at least one further device 102, e.g. with a plurality of further devices 102. Illustratively, a device 102 may have a communication channel 104 (e.g., a physical link) with one or more other devices 102. The devices 102 may illustratively be networked devices, or network participants. A device 102 may illustratively be a node of the network 100.

The approach described herein may in general be applicable to wired and/or wireless communication. A device 102 may thus be configured for wired and/or wireless communication (e.g., a device 102 may be a wireless communication device and/or a wired communication device). Accordingly, a communication channel 104 between two devices 102 may be a wired communication channel (e.g., an electrically conductive wire, an Ethernet cable, an optical fiber, etc.) or a wireless communication channel (e.g., air over which the devices 102 communicate via radio signals). In an exemplary configuration two devices 102 may be communicatively coupled via more than one communication channel 104, e.g. via a plurality of wired and/or wireless communication channels.

A device 102 may be or may include any mobile or immobile device capable of communicating with other devices. As examples, a device 102 may include User Equipment (UEs), Mobile Stations (MSs), Stations (STAs), cellular phones, gaming consoles, tablets, laptops, personal computers, wearables, multimedia playback and other handheld or body-mounted electronic devices, consumer/home/office/commercial appliances (e.g., a smart television, a smart refrigerator, etc., in an Internet of Things implementation), vehicles (e.g., a car, or a drone), an automated machine, a robot, and any other electronic device capable of communications. Without loss of generality, in some cases a communication device may also include application-layer components, such as application processors or other general processing components that are directed to functionality other than communications.

As further examples, a device 102 may include any type of base station or access point, including macro base stations, micro base stations, NodeBs, evolved NodeBs (eNBs), Next Generation NodeBs (gNBs), Home base stations, Remote Radio Heads (RRHs), relay points, Wi-Fi/WLAN Access Points (APs), Bluetooth master devices, dedicated short range communication roadside units (DSRC RSUs), communication devices acting as network access nodes, multi-standard radio (MSR) equipment, and any other electronic device capable of wired and/or wireless communications, including both immobile and mobile devices.

In an exemplary configuration, which may represent a relevant use case for the strategy described herein, a device 102 may be or include an automated machine (e.g., part of a control system, e.g. part of a control loop). A “machine” may include any type of mechanical structure that uses (e.g., electrical) power to alter its environment, to apply forces, to control movement and/or to perform an intended action, e.g., a mechanical structure programmable by a computer. By way of example, a machine may be a driven object with a combustion engine, a reaction engine, an electrically driven object, a hybrid driven object, or a combination thereof. A machine may be or may include a humanoid machine, a non-humanoid machine, an agricultural machine, a machine tool, a moving machine, a stationary machine, a drone, an industrial machine, a medical operating machine, a collectively operating machine, a ground machine, an aerial machine, an aquatic machine, or a combination thereof, among others.

The term “automated machine” may describe a machine capable of managing one or more tasks at least partially without human intervention, input, and/or control. Examples of the automated machine may include a hybrid machine, a human assisted machine and/or an autonomous machine. Exemplary components of managing task may include: managing one or more physical tasks (also referred to as task management), planning the task performance, organizing the task performance, scheduling the task performance, switching between two tasks, competing for one or more task, assigning one or more tasks, completing one or more tasks, reporting about completion of the one or more tasks, negotiation of the allocation of one or more tasks (e.g., between multiple automated machines), monitoring the progress of one or more tasks, navigate the automated machine to one or more positions of one or more tasks (e.g., at which the one or more task require a physical manipulation), etc.

In general, the communication network 100 may be configured according to any suitable wired- and/or wireless communication protocol, e.g. the communication network 100 may be a wired communication network, a wireless communication network, or a network including both wired and wireless communication. Communication within the network 100 may be governed by communication protocols that can vary depending on the specifics of communication network 100. Such communication protocols may define the scheduling, formatting, and routing of traffic (e.g., frames, data packets, etc.) through network 100. Accordingly, the devices 102 may follow the defined communication protocols to transmit and receive data within the communication network 100. Exemplary communication standars and protocols include LTE, UMTS, GSM, WiMAX, Bluetooth, WiFi, mmWave, etc., any of which may be applicable to network 100.

In an exemplary configuration that represents a relevant use case for the strategy described herein, the network 100 may be a Local Area Network (LAN). Illustratively, the network 100 may be configured according to a Local Area Network communication protocol or standard (e.g., IEEE 802.11, 802.11, 802.11a, 802.11b, 802.11g, 802.11n, 802.11p, 802.11-12, 802.11ac, 802.11ad, 802.11ah, among others). A LAN (e.g., a wired-LAN or wireless-LAN) may describe a network in which the networked devices 102 are located in a spatially confined region, such as within a factory, an enterprise, a university campus, a hospital, a home, etc.

In an exemplary configuration, the network 100 may be a packet switched network (PSN). In this scenario, data transmitted over the network are divided into packets which include identification information, address information, etc. Data transmitted from a device 102 (a source) to another device 102 (a destination) may thus be segmented into data packets, to allow an efficient utilization of the communication channel(s) 104.

In an exemplary configuration that represents a relevant use case of the strategy described herein, the communication network 100 may be associated with one or more time-critical operations. The networked devices 102 may be configured to carry out one or more time-critical operations, e.g. one or more operations for which a shared understanding of time is to be provided among the networked devices 102. Illustratively, the networked devices 102 may be configured to receive (and process) time-critical information and operate accordingly to carry out a respective task or sub-task as part of a time-critical operation. For example, the network 100 may be a “real-time” system, or may be part of a “real-time” system. As an example, the network 100 may be or define a control loop including the networked devices 102 (e.g., at least one device 102 may be a controller, and one or more other devices 102 may be one or more actuators). The network 100 may be, for example, a synchronous timing system or synchronous timing network. It is however understood that the strategy described herein may in general be applied to other scenarios.

Various protocols and standards exist for providing a common understanding of time among the devices 102 of a communication network 100. An example is the Network Time Protocol (NTP) which allows synchronizing system clocks of devices over the Internet. NTP however only ensures accuracy in the millisecond range, which may be not sufficient for applications that require high precision. A further example is the Precision Time Protocol (PTP), which was originally described in the IEEE 1588-2002 standard and which is designed to allow the networked devices to synchronize their clocks with sub-microseconds accuracy. Illustratively, PTP is a time transfer protocol that enables clocks in the devices of a network to synchronize to a reference clock. An extension of PTP is the so-called generalized Precision Time Protocol (gPTP), which is more robust against delay variations compared to PTP.

In this context, Time-Sensitive Networking (TSN) refers to a set of standards specified by the IEEE 802.1 standard (e.g., IEEE 802.1Q-2018, IEEE 802.1AB-2016, IEEE 802.1AS-2020, IEEE 802.1AX-2020, IEEE 802.1CB-2017, IEEE 802.1CS-2020, IEEE 802.1BA-2021, IEEE 802.1CM-2018, among others). The TSN-standard defines mechanisms for deterministic communication. The TSN-Standard ensures data transport with bounded low-latency, low-delay variation, and extremely low-loss. Time synchronization is a very important aspect of TSN. All devices that are participating in real-time communication may have a common understanding of time, and to achieve such common understanding may synchronize their clocks with each other. TSN standards have been initially developed in the context of wired-based communication, as an extension of the Ethernet standard, and have recently been introduced also for wireless-based communication. Many wireless TSN use-cases may be realized, for example, with 5G, 6G, WIFI6, WIFI7, etc. In general, TSN may make use of PTP (or gPTP) for distributing time synchronization information. As a difference with respect to PTP, TSN regulates communication at the Data-Link layer (layer 2) of the OSI Reference Model.

In an exemplary configuration, which may represent a relevant use case for the strategy described herein, the network 100 may be configured according to the TSN-standard. In this scenario, the devices 102 may be PTP-enabled devices, e.g. the devices 102 may be TSN-enabled devices. It is however understood that the network 100 may also be configured according to other types of standards and/or protocols.

The communication network 100 may be configured to propagate time synchronization information through the network 100 to allow a time synchronization among the devices 102 (illustratively, to cause the devices 102 to have synchronized clocks, e.g. synchronized clock signals). In the network 100 one of the devices 102, e.g. the device denoted as 102-0, may assume the role of reference clock for the network 100, e.g. the role of grandmaster clock. Illustratively, the device 102-0 may define a timing reference for the network 100. For example, according to PTP, the hierarchical arrangement of the devices 102 to identify which device 102-0 assumes the role of grandmaster may be carried out according to the Best Master Clock Algorithm (BMCA). Without loss of generality, the device 102-0 may be referred to in the following as grandmaster device 102-0, and a clock 108-0 of the grandmaster device 102-0 may be referred to as grandmaster clock.

The grandmaster device 102-0 may have the greatest clock quality among the devices 102 of the network 100. For example, the grandmaster device 102-0 may include or may be coupled with a quality clock source 106 configured to provide a time reference (e.g., UTC-based time synchronization information). As an exemplary configuration, the grandmaster device 102-0 may include a Global Positioning System (GPS) antenna and may be configured to receive GPS signals including time information (e.g., UTC time information) to synchronize the clock 108-0 of the grandmaster device 102-0 to an atomic clock. In general, a network 100 may include more than one grandmaster device 102-0, with one of the gradnmasters being active and providing the reference clock, and the other grandmaster(s) being in a standby state to be used as backup if the clock of the active granmaster 102-0 becomes unavailable.

Time synchronization information (e.g., in form of data packets, such as gPTP data packets) may propagate through the network 100 to allow the networked devices 102 to synchronize their clock 108 to the clock 108-0 of the grandmaster device 102-0. In an equilibrium state, all the clocks 108 are synchronized to the clock 108-0 of the grandmaster device 102-0. The time synchronization information may propagate between pairs of ports 110, 112 (illustratively, from an egress port 112 to an ingress port 110). An ingress port 110 may also be referred to as input port, and an egress port 112 may also be referred to as output port.

The propagation of the time synchronization information may occur with one device 102 assuming the role of leader and another device 102 assuming the role of follower. A device 102 may have more than one role, and may be the follower of another device 102, and the leader of a further device 102. According to PTP, a device 102 may carry out a negotiation with the devices 102 with which it is communicatively coupled, to determine the respective role. By way of illustration, a follower device 102 may receive time synchronization information from the resepctive leader device 102, and a leader device 102 may transmit time synchronization information to one or more follower devices 102.

Starting from the grandmaster device 102-0 as root for the propagation of time synchronization information, the grandmaster device 102-0 may transmit the time synchronization information to a first (follower) device 102-1. In this scenario, the grandmaster device 102-0 may be a leader for the first device 102-1, so that the egress port 112 of the grandmaster device 102-0 may be in a leader state (or master state), and the first device 102-1 may be a follower for the grandmaster device 102-0, so that the ingress port 110 of the first device 102-1 may be in a follower state (or slave state).

The first device 102-1 may synchronize its clock 108-1 to the clock 108-0 of the grandmaster device 102-0 according to the received time synchronization information (see also FIG. 1B), and may further propagate the time synchronization information to other devices 102-2, 102-3, 102-4 with which the first device 102-1 is communicatively coupled. In this scenario, the first device 102-1 may assume the role of leader device with respect to the other devices 102-2, 102-3, 102-4, so that the egress ports 112 of the first device 102-1 may be in a leader state, and the respective ingress port 110 of the other devices 102-2, 102-3, 102-4 may be in a follower state. The other devices 102-2, 102-3, 102-4 may then synchronize the respective clock 108-2, 108-3, 108-4 to the clock 108-1 of the first device 102-1 (which is synchronized to the clock 108-0 of the grandmaster device 102-0). The propagation of the time synchronization information may continue accordingly until all devices 102 received time synchronization information.

In the exemplary scenario of PTP (and TSN), a device 102 may be of various types. A first type may be an ordinary clock, which may be an end-device with a single port (e.g., a single ingress port 110 or a single egress port 112) and a local clock 108. An ordinary clock may either assume the role of follower (as it is the case, for example, for the devices 102-2, 102-5, 102-6), illustratively of a leaf in the tree, or the role of grandmaster (as it is the case for the device 102-0), illustratively the root of the tree. An ordinary clock may illustratively be an end-point clock.

A second type may be a boundary clock (BC), which is a device with a plurality of ports (e.g., one or more ingress ports 110 and/or one or more egress ports 112), and one local clock shared among the ports. A boundary clock may assume the role of grandmaster of the network. Alternatively, a boundary clock may be configured to select the clock with the highest quality among the clocks seen by its ports. The corresponding (ingress) port assumes a follower state to receive time synchronization information for synchronizing the local clock. The other ports may assume a leader state delivering time synchronization information based on the synchronized local clock. In the exemplary configuration in FIG. 1A, the devices 102-1, 102-3, 102-4 may be boundary clocks receiving time synchronization information from a respective leader, and delivering time synchronization information to respective follower(s). A boundary clock may be illustratively a switch (e.g., a bridge) that distributes time synchronization information within the network 100. A boundary clock may illustratively be a network device clock.

A third type may be a transparent clock (TC), e.g. end-to-end transparent clock or peer-to-peer transparent clock. A transparent clock may have a plurality or ports and a local clock. As a difference with respect to a boundary clock, a transparent clock may deliver time synchronization information by adding to the received time synchronization information the so-called residence time, which may represent the time that the information spent in the transparent clock. For example, the transparent clock may add the residence time to a correction field of a message including the time synchronization information. A transparent clock may illustratively be a network device that measures and transmits residence time (illustratively, latency), but does not participate in the protocol.

It is understood that in general the network 100 may also include further networked devices that do not participate to the time synchronization, e.g. non-PTP devices, for example devices configured to carry out managing functions, or other non time-critical operations within the network 100. It is also understood that the definition of the type of devices may depend on the communication protocol or standard used in the network 100. As a further example, considering gPTP, the devices may either be a so-called “end instance” (e.g., corresponding to a PTP ordinary clock) or a so-called “relay instance” (e.g., corresponding to a PTP boundary clock, or transparent clock).

FIG. 1B shows an exemplary diagram 120 illustrating a data flow between a leader device 122 and a follower device 124 according to the present disclosure. In general, time synchronization information may propagate through a communication network in any suitable manner depending on the selected communication standard or protocol. Illustratively, each communication standard or protocol may define parameters and properties of the transmission/reception of time synchronization information, e.g. a type of message, a type of data packet, a scheduling of transmission/reception, a type of acknowledgment, a redundancy, and/or the like. The general principles of transmission/reception of time synchronization information and the synchronization of a clock of a follower device to the clock of a leader device may be known in the art. FIG. 1B illustrates an exemplary configuration to introduce some general aspects and describe an exemplary communication flow for transmission and reception of time synchronization information. It is however understood that the strategy described herein is not limited to scenarios including the communication flow shown in FIG. 1B.

The diagram 120 illustrates an exemplary scenario in which the leader device 122 is directly coupled with the follower device 124, without intervening nodes (e.g., without transparent clocks therebetween). The scenarios with intervening nodes will be described in further detail below. FIG. 1B may show how a follower device 124 may synchronize its clock based on time synchronization information from the leader device 122. As an example, the leader device 122 may be a grandmaster device, or a boundary clock, and the follower device 124 may be a ordinary clock (or another boundary clock).

The leader device 122 may transmit a message 126 including time synchronization information to the follower device 124. The time synchronization information may assume any suitable form to allow the follower device 124 to synchronize its clock to the clock of the leader device 122. As an example, the message 126 may be a sync message including a timestamp of the clock of the leader device 122 (which may correspond to a timestamp of the clock of the grandmaster device). Illustratively, for example, the time synchronization information may represent a current time of the clock of the leader device 122, e.g. may be a timestamp in leader time. In an exemplary configuration, the message 126 may be or include a data packet, e.g. a time synchronization packet (such as a PTP packet, or a gPTP packet). In general, the time may be expressed in any suitable unit, and with any suitable resolution, depending on the type of application.

The leader device 122 may transmit the message 126 at a time t₁, and the message 126 is received at the follower device 124 at a time t₂ (illustratively, after a delay Δt, e.g. due to network latency). In a two-step configuration (as shown in FIG. 1B), the leader device 122 may further transmit a follow-up message 128 representing the time t₁ at which the message 126 was sent. The follow-up message 128 may provide taking into account for internal delay of the leader device 122 between the generation of the message 126 and its actual transmission. A simpler configuration may be a one-step method (not shown), in which the follow-up message 128 is absent.

To carry out the synchronization, the follower device 124 may use a knowledge about a delay associated with the communication path between the leader device 122 and the follower device 124. To gain a knowledge of the delay (illustratively, a round-trip delay), the follower device 124 may transmit a delay request message 130 to the leader device 122, e.g. at a time t₃. The delay request message 130 may include identification information of the follower device 124 to allow the leader device 122 to know from which device originated the delay request. The delay request message 130 may prompt the leader device 122 to send a delay response message 132. The delay response message 132 may indicate the time at which the leader device 122 received the delay request message 130, e.g. a time t₄ (illustratively, after a second delay Δt*).

The follower device 124 may now determine (e.g., calculate) a mean path delay (MPD) based on the timestamps t₁, t₂, t₃, and t₄, e.g. as MPD=((t₂−t₁)+(t₄−t₃))/2. The follower device 124 may then determine a clock offset (TO) between the clock of the follower device 124 and the clock of the leader device 122 using the MPD, e.g. as TO=t₂−t₁−MPD, and may use the determined offset to correct its own clock and synchronize with the clock of the leader device 122. For example, the follower device 124 may modify the next clock value so that such clock value corresponds to the clock value of the leader device 122. As another example, additionally or alternatively, the follower device 124 may increase or decrease a clock rate of its clock to synchronize with the clock of the leader device 122.

If there are intervening devices between the leader device 122 and the follower device 124, e.g. one or more transparent clocks considering a PTP context, the residence time within each of the transparent clocks is taken into account when determining the offset. In this regard there may be two possible approaches, so-called End-to-End synchronization and Peer-to-Peer synchronization.

In End-to-End synchronization, each transparent clock adds a correction field to each message delivered to the follower device 124. The correction field represents the residence time for that message within the transparent clock. In this configuration, the follower device 124 receives information about the timestamp t₁ including a sum of all the residence times of all the involved transparent clocks along the path between the leader device 122 and the follower device 124. Similarly, the follower device 124 receives information about the timestamp t₄ including a sum of all the residence times of all the involved transparent clocks (which may be different with respect to the residence times for the timestamp t₁).

In Peer-to-Peer synchronization the delays are determined between pairs of involved devices, e.g. between the leader device 122 and a transparent clock, and between the transparent clock and the follower device 124, as an example, rather than considering the cumulated delay along the entire propagation path. In this scenario, the transparent clock transmits a delay request to the leader device 122 (or, in general, to the device upstream in the propagation path) and receives a corresponding delay response. The transparent clock may include the delay information in the correction field (in addition to the residence time). The follower device 124 transmits a delay request to the transparent clock and receives a corresponding delay response, etc.

In general, a synchronization may be repeated multiple times, e.g. at regular time intervals, to ensure that synchronization is maintained within the network. The grandmaster device of a communication network may thus transmit time synchronization information, which then propagates through the network, at predefined time intervals (illustratively, predefined transmission intervals). The time interval at which the grandmaster device (or, in general, a leader device) transmits time synchronization information may be adapted depending on one or more properties of the network, e.g. depending on a (e.g., time-critical) operation to be carried out, depending on a knowledge of network latency, on a number of networked devices, etc. As a numerical example, a time synchronization interval may have a duration of less than 5 seconds, for example less than 3 seconds, for example 1 second, for example 100 milliseconds.

FIG. 1C shows an exemplary communication device 150 in a schematic representation, according to the present disclosure. The communication device 150 may represent an exemplary configuration of a device 102 of the communication network 100, e.g. an exemplary configuration of the communication-related components of a device 102 of the communication network 100.

In general, the communication device 150 may include one or more processors 152, one or more memories 154 coupled with the one or more processors, and one or more communication interfaces 156. It is understood that the configuration illustrated in FIG. 1C is exemplary, and a communication device 150 may include additional, less, or alternative components with respect to those shown. As examples, the communication device 150 may include one or more additional hardware and/or software components depending on its configuration and its intended use, such as processors/microprocessors, controllers/microcontrollers, other specialty or generic hardware/processors/circuits, peripheral device(s), power supply, external device interface(s), subscriber identity module(s) user input/output devices (display(s), keypad(s), touchscreen(s), speaker(s), external button(s), camera(s), microphone(s), etc.), or other related components.

The one or more communication interfaces 156 may include one or more transceivers 158. The communication interfaces 156 (and the transceivers 158) may be configured according to any suitable wired and/or wireless communication protocol or standard to be implemented via the communication device 150.

As an example, for wireless communication, a communication interface 156 may include or may be coupled with one or more antennas, e.g. one or more directional or omnidirectional antennas, e.g. a single antenna or an antenna array that includes multiple antennas. The one or more antennas may include, for example, dipole antennas, monopole antennas, patch antennas, loop antennas, microstrip antennas, or other types of antennas suitable for transmission of radio frequency signals. As an exemplary configuration, an antenna may have multiple apertures, each of which may be considered as an antenna. In an exemplary configuration, the communication device 150 may additionally include analog antenna combination and/or beamforming circuitry. In this scenario, the communication device 150 may be configured to transmit and/or receive wireless signals via the antennas, e.g. radio signals over an air interface.

As another example, for wired communication, a communication interface 156 may be or include an Ethernet interface. In this configuration, a communication interface 156 may include or may be coupled with a cable, e.g. an Ethernet cable, and the communication device 150 may be configured to transmit and/or receive signals via the cable.

In general, a transceiver 158 may include one or more components to process a signal received at the communication device 150 and/or a signal to be transmitted from the communication device 150. As examples, a transceiver may include analog and digital reception components including amplifiers, e.g., Low Noise Amplifiers (LNAs), Power Amplifiers (PAs), filters, demodulators (e.g., radiofrequency demodulators), analog-to-digital converters (ADCs), digital-to-analog converters (DACs), mixers, and the like.

The one or more processors 152 may be configured for transmission and reception processing. The one or more processors 152 may include, for example, a baseband modem 160 (e.g., including a digital signal processor and a protocol controller). The baseband modem 160 may be configured to direct the communication functionality of the communication device 150 according to the communication protocols associated with each network, and may be configured to execute control over the communication interfaces 156 to transmit and receive signals (e.g., radio signals) according to the formatting and scheduling parameters defined by each communication protocol.

The baseband modem 160 may include a digital signal processor, which may be configured to perform physical layer (PHY, Layer 1) transmission and reception processing to, in the transmit path, prepare outgoing transmit data that the protocol controller provides for transmission via the communication interfaces 156, and, in the receive path, prepare incoming received data that the communication interfaces 156 provide for processing by the protocol controller. Digital signal processor may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancellation, and any other physical layer processing functions.

In an exemplary configuration, the communication device 150 may be configured to operate according to one or more radio communication technologies, and the digital signal processor may be responsible for lower-layer processing functions (e.g., PHY, Layer 1) of the radio communication technologies, while the protocol controller may be responsible for upper-layer protocol stack functions (e.g., Data Link Layer/Layer 2 and/or Network Layer/Layer 3). Protocol controller may be configured to perform both user-plane and control-plane functions to facilitate the transfer of application layer data to and from communication device 150 according to the specific protocols of the supported radio communication technology.

In an exemplary configuration, communication device 150 may be configured to transmit and receive data according to multiple communication technologies. Accordingly, one or more of communication interfaces 156, transceivers 158, digital signal processor, and/or protocol controller may include separate components or instances dedicated to different communication technologies and/or unified components that are shared between different communication technologies.

The one or more processors 152 may further include an application processor 162 (e.g., a CPU) and a memory. Application processor 162 may be configured to handle the layers above the protocol stack, including the transport and application layers. Application processor 162 may be configured to execute various applications and/or programs at an application layer of the communication device 150, such as an operating system (OS), a user interface (UI) for supporting user interaction, and/or various user applications. The application processor 162 may interface with baseband modem 160 and act as a source (in the transmit path) and a sink (in the receive path) for user data, such as voice data, audio/video/image data, messaging data, application data, basic Internet/web access data, etc. As further examples, the one or more processors 152 may include an image processor, a communication processor, a signal processor, and/or any other suitable processing device.

The one or more memories 154 may embody a memory component of the communication device 150, such as a hard drive or another such permanent memory device. Although not explicitly depicted in FIG. 1C, the various other components of the communication device 150 may additionally each include integrated permanent and/or non-permanent memory components, such as for storing software program code, buffering data, etc.

In an exemplary configuration, the communication device 150 may also include one or more data interfaces communicatively connecting the one or more processors 152 to other components of the communication device 150. For example, the one or more data interfaces may be configured to exchange data in accordance with a fieldbus communication protocol or another in-machine communication protocol.

One or more of the transceivers 158 may be configured to implement a group communication protocol (e.g., including a data exchange protocol, e.g., a wireless data exchange protocol and/or a wired data exchange protocol), and optionally one or more other communication protocols. In some aspects, the group communication protocol may be or include a proprietary (e.g., wireless and/or wired) communication protocol. In an exemplary configuration, the group communication protocol may be an application layer protocol, e.g., defining the format, syntax, and/or semantics of the load part of a message generated in accordance with a (e.g., wireless and/or wired) communication protocol.

Any of the processors 152 disclosed herein may be configured to perform certain functions in accordance with program instructions which may be stored in a memory of the one or more memories 154. In other words, a memory of the one or more memories 154 may store software that, when a processor (e.g., the one or more processors 152) executes, controls the operation of the system, e.g., of the communication device 150. A memory of the one or more memories 154 may store one or more databases, as well as a trained system, such as a neural network, or a deep neural network, for example. The one or more memories 154 may include any number of random access memories, read only memories, flash memories, disk drives, optical storage, tape storage, removable storage and other types of storage.

The adapted strategy to ensure operational continuity in a network will be described in relation to FIG. 2 to FIG. 10. Illustratively, the approach described herein may be understood as a dynamic and reactive network management in case of failed delivery of time synchronization information.

FIG. 2 illustrates a device 200 in a schematic view according to various aspects. The device 200 may include a processor 202 and storage 204 (e.g., one or more memories) coupled to the processor 202. The storage 204 may be configured to store instructions (e.g., software instructions) executed by the processor 202. The instructions may cause the processor 202 to perform a method 210 of operating a communication network (e.g., the communication network 100), described in further detail below. Aspects described with respect to a configuration of the processor 202 may also apply to the method 210, and vice versa. Illustratively, the device 200 may be a network manager, or a network controller.

In accordance with the method 210, the processor 202 may be configured to control (e.g., direct, or instruct) an operation of a device 212 to reactively adapt to missing time synchronization information 216. In general, the method 210 may be applied to any suitable device 212 that is capable of communicating with another device 214, e.g. any suitable device 212 capable of receiving time synchronization information 216 from another device 214. In an exemplary configuration, the method 210 may be applied to a scenario involving a follower device 212 and a leader device 214, e.g. configured as described in relation to FIG. 1A to FIG. 1C. In this scenario, the device 212 may be a follower device, and the other device 214 from which the device 212 should receive time synchronization information 216 may be a leader device. Illustratively, the device 212 may have or assume a follower role with respect to the other device 214, and the other device 214 may have or assume a leader role with respect to the device 212. In the following, without loss of generality, the device 212 will be referred to as follower device, and the other device 214 will be referred to as leader device.

In an exemplary configuration, the operation of the device 200 may be carried out in a communication network configured according to the PTP protocol. For example, the operation of the device 200 may be carried out in a communication network configured according to the TSN-standard. In this scenario, the follower device 212 may be an ordinary clock (or a boundary clock), and the leader device 214 may be a boundary clock or a grandmaster clock of the communication network. Illustratively, in an exemplary configuration the follower device 212 and the leader device 214 may be PTP-enabled devices, e.g. may be TSN-enabled devices.

In general, the network manager 200 may be a dedicated device in a communication network (e.g., in the communication network 100). For example, the network manager 200 may be physically located in the communication network, e.g., in the LAN, or it may be located elsewhere (illustratively, in the “cloud”) and communicatively coupled to the network participants. In another configuration, the functions of the network manager 200 may be implemented by one of the devices of the network, e.g. by the follower device 212, the leader device 214, a grandmaster device etc. For example, the processor 202 may be one of the one or more processors 152 of a communication device 150. In a preferred configuration, the processor of the follower device 212 may carry out the aspects described in relation to the processor 202. Illustratively, in this scenario the device 200 may be the follower device 212 at which a reception of time synchronization information fails. This may ensure a rapid process, and may ensure maintaining the overall synchronization within the network within a predefined accuracy.

In the exemplary representation in FIG. 2, the follower device 212 and the leader device 214 are shown as directly coupled to one another. It is however understood that the aspects described in relation to such exemplary configuration may apply in a corresponding manner to a scenario in which one or more further devices are disposed along the communication path between the follower device 212 and the leader device 214. For example, in another configuration, one or more transparent clocks (or one or more further boundary clocks) may be interposed between the follower device 212 and the leader device 214.

The processor 202 may be configured to detect a failed reception of time synchronization information 216 at the follower device 212, e.g. a failed reception of time synchronization information 216 at a clock 218 of the follower device 212. Illustratively, the processor 202 may be configured to determine if a time synchronization at the follower device 212 fails. For example, the processor 202 may be configured to determine whether the follower device 212 successfully received time synchronization information 216, e.g. at a predefined time point (e.g., after a predefined time interval). Stated in a different fashion, the processor 202 may be configured to determine whether a loss of time synchronization information 216 occurred in a communication link coupling the leader device 214 with the follower device 212. A failed reception may include, illustratively, that an expected (illustratively, scheduled, or anticipated) reception of time synchronization information 216 at the follower device 212 did not take place.

The time synchronization information 216 may be configured to provide (e.g., to instruct) an update of a clock 218 of the follower device 212 for synchronization to a clock 220 of the leader device 214. Illustratively, the time synchronization information 216 may be or include information that the follower device 212 may use to synchronize the clock 218 to the (leader) clock 220 of the leader device 214. The time synchronization information 216 may thus be configured to cause an adjustment of the clock 218 of the follower device 212 to obtain a shared notion of time with the leader device 214. For example, the clock 218 of the follower device 212 may be a system clock of the follower device 212. As another example, the clock 218 of the follower device 212 may include a hardware clock of the follower device 212. The clock 218 of the follower device 212 may also be referred to herein as follower clock 218, and the clock 220 of the leader device 214 may also be referred to herein as leader clock 220.

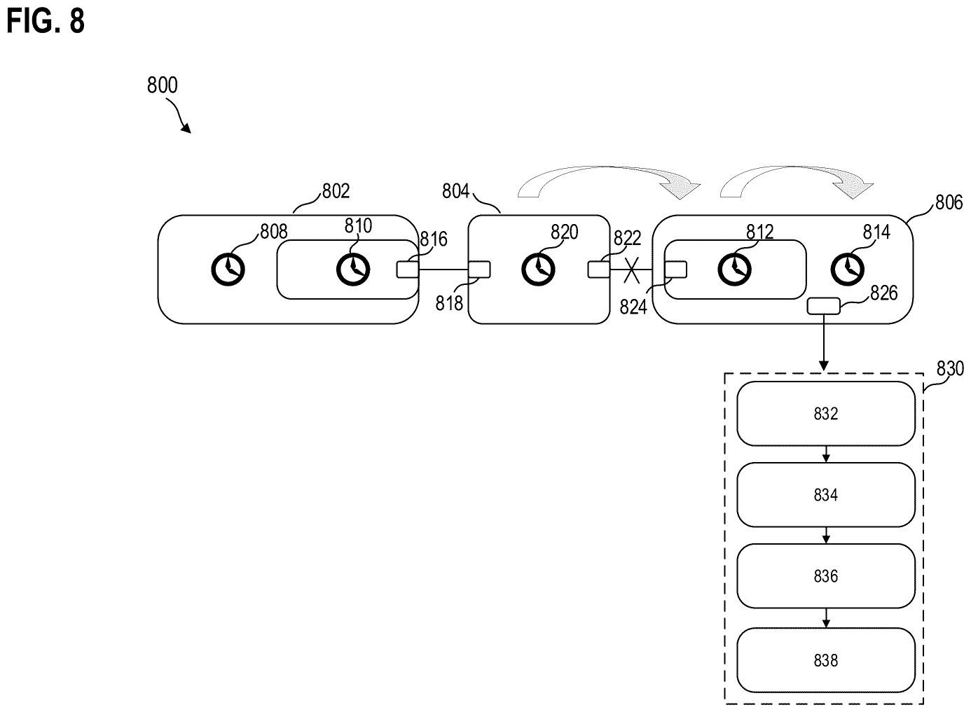

In general, a follower device 212 or leader device 214 may include more than one clock. For example, the follower device 212 may include a system clock and a hardware clock, and/or the leader device 214 may include a system clock and a hardware clock. In an exemplary configuration (see also FIG. 8) the hardware clock of the leader device 214 may be synchronized to the system clock of the leader device 214, and the time synchronization information 216 include information to synchronize to the hardware clock (and correspondingly to the system clock) of the leader device 214. In this scenario, the follower device 212 may, in general, receive time synchronization information at the hardware clock, to synchronize the (follower) hardware clock to the (leader) hardware clock of the leader device 214. The follower device 212 may then adjust its (follower) system clock to synchronize with its (follower) hardware clock, thus synchronizing overall with the (leader) system clock of the leader device 214.

In the present disclosure, references to synchronizing the follower clock 218 to the leader clock 220 may thus include a synchronization of the follower system clock to the leader system clock, and/or of the follower hardware clock to the leader hardware clock, and/or combinations thereof. It is also understood that the aspects described, in general, in relation to the follower clock 218 may apply in a corresponding manner to the follower hardware clock and/or follower system clock, and the aspects described, in general, in relation to the leader clock 220 may apply in a corresponding manner to the leader hardware clock and/or leader system clock.

As discussed in relation to FIG. 1A to FIG. 1C, the time synchronization information 216 (and, in general, time synchronization information delivered by the leader device 214) may include or represent any suitable information to enable synchronizing the clock 218 of the follower device 212 to the clock 220 of the leader device 214. As an example, the time synchronization information 216 may include or represent a timestamp of the clock 220 of the leader device 214. Illustratively, the time synchronization information 216 may include or represent a clock value (e.g., a time of day) of the clock 220 of the leader device 214. As another example, additionally or alternatively, the time synchronization information 216 may include or represent a clock rate of the clock 220 of the leader device 214. As a further example, additionally or alternatively, the time synchronization information 216 may include or represent a clock phase of the clock 220 of the leader device 214. In an exemplary configuration, e.g. in case of intervening devices between the follower device 212 and the leader device 214, the time synchronization information 216 may include one or more correction values (e.g., part of a correction field), e.g. one or more values representing one or more residence times, one or more intermediate delays, etc. For example, the time synchronization information 216 may be time information of the leader clock 220, e.g. clock information of the leader clock 220.

In general the time synchronization information 216 may have any suitable form for propagation within a communication network. For example, a time synchronization message may include or represent the time synchronization information 216. In an exemplary configuration, which may represent a relevant use case for the strategy described herein (e.g., in the context of a PSN), a data packet may include or represent the time synchronization information 216. Illustratively, such data packet may be a time synchronization packet (or more than one synchronization packets) originating from the leader device 214.

In an exemplary configuration the processor 202 may thus be configured to detect the failed reception of time synchronization information 216 by detecting a failed reception of a time synchronization packet at the follower device 212 (e.g., at the follower clock 218, for example at the follower hardware clock). Illustratively, the processor may be configured to detect a packet loss of one or more time synchronization packets that should have been delivered to the follower device 212. In an exemplary configuration, a time synchronization packet may be or include a PTP packet, e.g. a generic Precision Time Protocol (gPTP) packet.

The processor 202 may be further configured to determine, for example upon detecting the failed reception of the time synchronization information 216, whether a clock drift 222 between the clock 218 of the follower device 212 and the clock 220 of the leader device 218 is within a predefined range (e.g., a predefined drift range). Illustratively, the processor 202 may be configured to determine (e.g., measure, or calculate) the clock drift 222 of the follower clock 218 with respect to the leader clock 220, and to determine (e.g., evaluate, or verify) whether the clock drift 222 is in the predefined range (illustratively, in an acceptance range).

The clock drift 222 may include or represent a difference between one or more clock parameters of the leader clock 220 and one or more corresponding clock parameters of the follower clock 218. By way of illustration, the clock drift 222 may be a parameter representing a deviation of the behavior of the follower clock 218 from the behavior of the leader clock 220. Stated in a different fashion, the clock drift 222 may be a parameter representing an asynchronization (e.g., the magnitude of an asynchronization) between the leader clock 220 and the follower clock 218.

The clock drift 222 may include any suitable parameter to represent a difference between the behavior of the follower clock 218 with respect to the behavior of the leader clock 220. As an example, the clock drift 222 may include a drift of a clock value of the clock 218 of the follower device 212 with respect to a clock value of the clock 220 of the leader device 214, e.g. the clock drift 222 may include a time difference between the follower clock 218 and the leader clock 220. As a further example, the clock drift 222 may include a drift of a clock rate of the clock 218 of the follower device 212 with respect to a clock rate of the clock 220 of the leader device 214. Illustratively, the clock drift 222 may include a difference between the clock rates, e.g. a difference between the oscillation frequencies of the follower clock 218 and the leader clock 220.

The clock value and the clock rate may represent relevant parameters that enable an efficient and reliable understanding of the synchronization scenario. It is however understood that the clock drift 222 may in general include or represent also other parameters to indicate the current synchronization status between the follower clock 218 and the leader clock 220. As a further example, the clock drift 222 may include a drift between a phase of a clock signal of the follower clock 218 and a phase of a clock signal of the leader clock 220.

The clock drift 222 being in the predefined range may include the clock drift 222 having a value in the predefined range. The value may represent the difference between the one or more clock parameters of the follower clock 218 with respect to the corresponding parameters of the leader clock 220. The predefined range may illustratively be a range of values for the clock drift 222 (e.g., a range of values for the drift of the clock value, a range of values for the drift of the clock rate, etc.) selected such that if the value is within the range the processor 202 may determine that the follower clock 218 is substantially synchronized with the leader clock 222, as discussed in further detail below. Illustratively, if the clock drift 222 is in the predefined range the processor 202 may be configured to determine that an acceptable synchronization exists between the follower clock 218 and the leader clock 220.

In an exemplary configuration, the processor 202 may be configured to determine whether the clock drift 222 is less than a predefined drift threshold. The predefined drift threshold may illustratively be or represent a limit (e.g., a maximum value) for the clock drift 222, below which it may be assumed that sufficient synchronization is (still) present between the follower clock 218 and the leader clock 220. For example, the predefined drift threshold may be an upper boundary of the predefined range. An exemplary implementation of the drift threshold and drift range will be described in further detail in relation to FIG. 4.

As mentioned above, the clock drift 222 may be expressed in terms of different parameters. As an example, which may be the most relevant use case, the predefined drift threshold may be a threshold for a drift of the clock value of the follower clock 218 with respect to a clock value of the leader clock 220 (e.g., expressed as an absolute value). As another example, additionally or alternatively, the predefined drift threshold may be a threshold for a drift of the clock rate of the follower clock 218 with respect to a clock rate of the leader clock 220 (e.g., expressed as an absolute value). As a further example, additionally or alternatively, the predefined drift threshold may be a threshold for a drift of the clock phase of the follower clock 218 with respect to a clock phase of the leader clock 220 (e.g., expressed as an absolute value).

It is understood that the aspects described herein in relation to the clock drift 222 being within a predefined drift range or being less than a predefined drift threshold may be correspondingly adapted to a scenario in which the opposite decisions are taken for the clock drift 222 being outside a predefined drift range or being greater than a predefined drift threshold.

In the case that the clock drift 222 is less than the predefined drift threshold (e.g., if the clock drift 222 is within the predefined range), the processor 202 may be configured to instruct an update 224 of the clock 218 of the follower device 212 based on time synchronization information previously received at the follower device 212. Illustratively, if the processor 202 determines that the synchronization between the clocks 218, 220 is within an acceptable range, the processor 202 may be configured to instruct an adjustment of the follower clock 218 even in absence of the time synchronization information 216.

The update 224 of the clock 218 of the follower device 212 may include adjusting (e.g., modifying) one or more clock parameters of the follower clock 218. For example, the update of the clock 218 of the follower device 212 may include an update of a clock value of the clock 218 for synchronization to a clock value of the leader clock 220. As another example, the update of the clock 218 of the follower device 212 may include an update of a clock rate of the clock 218 for synchronization to a clock rate of the leader clock 220. As mentioned above, these two parameters may be the most relevant for maintaining synchronization within a network, but it is understood that also other parameters may be considered. As a further example, the update of the clock 218 of the follower device 212 may include an update of a clock phase of the clock signal of the clock 218 for synchronization to a clock phase of the leader clock 220.

The processor 202 may illustratively be configured to generate an instruction signal representing the update of the follower clock 218. The instruction signal may include or represent one or more adjustment values for adjusting one or more clock parameters of the follower clock (e.g., the clock value, the clock rate). The processor 202 may be configured to transmit (or cause a transmission) of the instruction signal to the follower device 212 (e.g., to a processor of the follower device 212 for causing the update 224 of the follower clock 218). In an exemplary configuration, the processor 202 may be configured to control the update 224, e.g. to cause the update 224, of the follower clock 218. After the instructing of the update 224, and after the carrying out of the update 224 at the follower device 212, the follower clock 218 may have modified clock parameter(s), e.g. a modified clock value, a modified clock rate, and/or a modified clock phase, as examples.

The time synchronization information previously received at the follower device 212 may include information that the follower device 212 received at previous time points (illustratively, time points prior to the failed reception of the time synchronization information 216). The previous time synchronization information may include, for example, one or more previous time synchronization messages, e.g. one or more previous time synchronization packets that the follower device 212 successfully received.

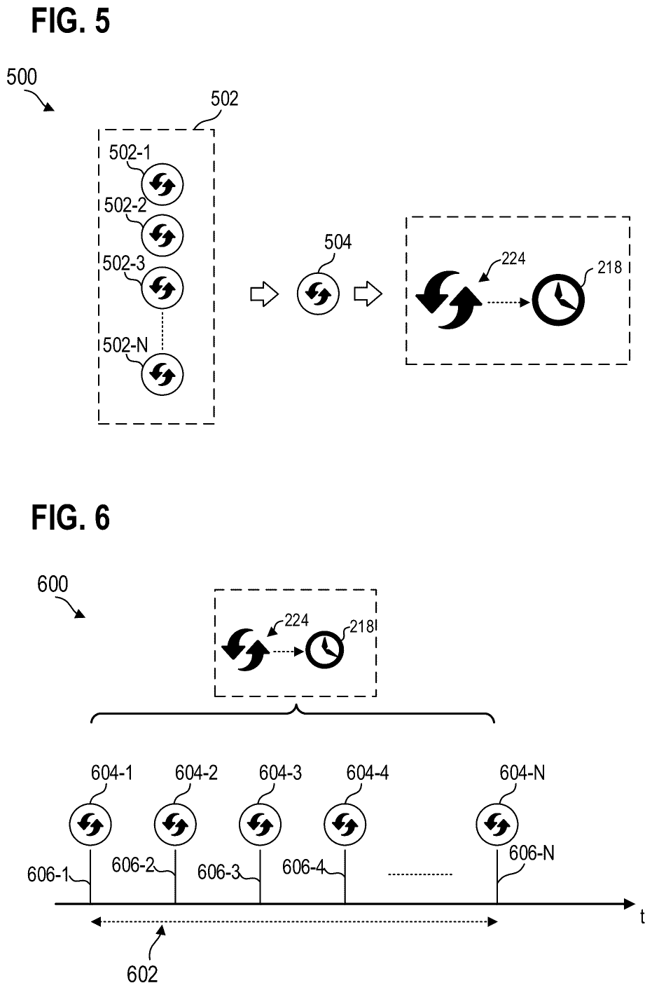

In general, the processor 202 may be configured to instruct the update 224 of the follower clock 218 based on historical data representing previous updates of the follower clock 218 (illustratively, as caused by the previous time synchronization information). By way of illustration, the processor 202 may be configured to instruct the next update 224 of the follower clock 218 using a previous knowledge of previous updates of the follower clock 218. The processor 202 may thus be configured to define adjustment values for the next update 224 based on previous adjustment values of one or more previous updates, as discussed in further detail below (see FIG. 5).

The strategy described herein may thus be based on the realization that even if a time synchronization fails due to a loss of time synchronization information 216, it may be possible to maintain a sufficient synchronization with the leader clock 220 using historical data to generate (e.g., infer) new adjustment values. The strategy described herein thus ensures that the follower device 212 may continue to operate (e.g., may continue to carry out a time-critical operation), even in case of a temporary disruption of the communication path with the leader device 214.

In an exemplary configuration, the functionalities of the processor 202 may be implemented via a plurality of dedicated circuits. For example, the device 200 may include a detection circuit for detecting the failed reception of the time synchronization information 216 at the follower device 212. As another example, the device 200 may include a clock drift determination circuit for determining the clock drift 222 of the follower clock 218 with respect to the leader clock 220. As a further example, the device 200 may include an update circuit for instructing (and/or causing) the update 224 of the follower clock 218.

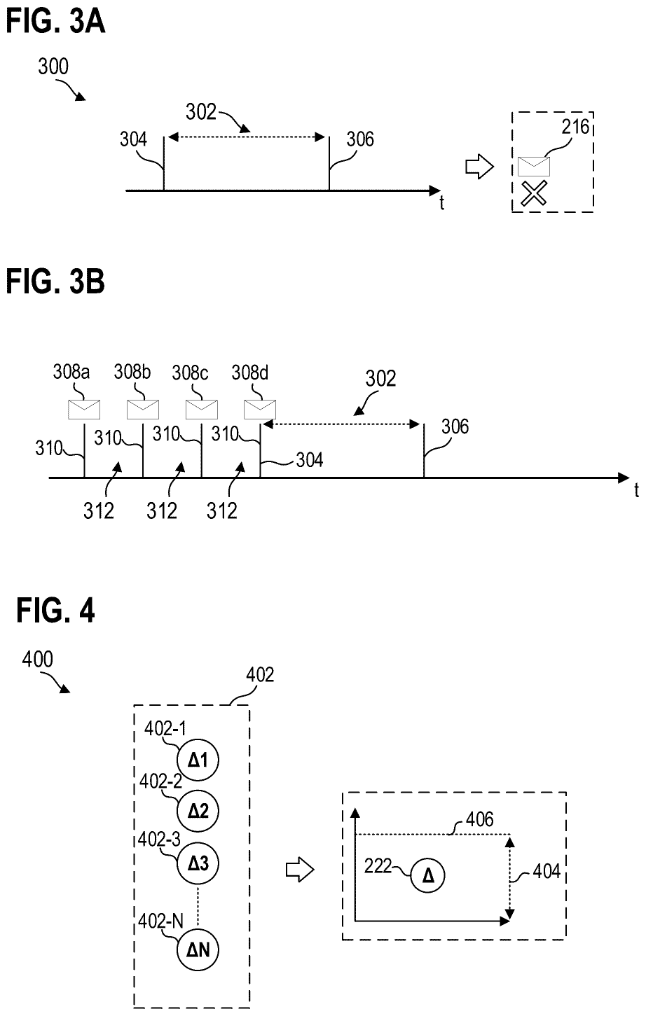

Various aspects of the operation of the processor 202 (e.g., various aspects of the method 210) will be described in further detail in relation to FIG. 3A to FIG. 10. The aspects describe in relation to FIG. 3A to FIG. 10 may be implemented as part of the method 210, or, in another configuration, may be implemented independently of the method 210, e.g. by dedicated devices (e.g., dedicated processors, e.g. dedicated circuits) communicatively coupled with the device 200.

FIG. 3A and FIG. 3B illustrate an exemplary detection 300 of a failed reception of time synchronization information at a follower device, in a schematic representation according to the present disclosure.

In general, there may be various mechanism to determine that a follower device 212 did not receive time synchronization information 216, e.g. there may be various mechanisms to detect a message loss, or a packet loss, in a communication network. FIG. 3A and FIG. 3B illustrate a strategy for determining the loss of time synchronization information 216, e.g. for determining that a time synchronization may fail, and trigger the subsequent determination of the clock drift 222 and instruction of the update 224. It is however understood that also other mechanisms may be provided.

As illustrated in FIG. 3A, the processor 202 may be configured to detect the failed reception of time synchronization information 216 at the follower device 212 (e.g., at the clock 218 of the follower device 212) by determining that a time synchronization interval 302 has elapsed without the follower device 212 receiving time synchronization information 216 during the time synchronization interval 302 (e.g., without the follower clock 218, e.g. the follower hardware clock, receiving time synchronization information). Illustratively, the processor 202 may be configured to determine that a loss of time synchronization information 216 occurred if the processor 202 determines that no time synchronization information was received at the follower device 212 before reaching a predefined time point.

The time synchronization interval 302 may be configured to ensure a reliable determination of an occurred loss of time synchronization information. A duration of the time synchronization interval 302 may be selected to take into account for various delays that may occur within the network during propagation of the time synchronization information, e.g., latency, residence time, etc. Illustratively, the processor 202 may be configured to define a duration of the time synchronization interval 302 to be greater than an average network latency, e.g. at least two times greater than the average network latency, e.g. at least five times greater than the average network latency.

As an exemplary implementation, the processor 202 may include a timer (e.g., a counter), and may be configured to start (e.g., to reset) the timer after each successful reception of time synchronization information at the follower device 212, to start measuring the passing of the time synchronization interval. Illustratively, the processor 202 may be configured to define an initial time point 304 for the time synchronization interval 302, e.g. after each successful reception of time synchronization information or after each successful update of the follower clock 218, as examples. The processor 202 may be configured to determine that a failed reception of (new) time synchronization information 216 occurred if the duration of the time synchronization interval 302 has elapsed (and thus an end time point 306 has been reached) without a successful reception of the (new) time synchronization information 216.

In an exemplary configuration, as shown in FIG. 3B, the duration of the time synchronization interval 302 may be a multiple of a predefined transmission interval 312 at which the leader device 214 is expected to transmit time synchronization information to the follower device 212. Illustratively, the leader device 214 may be configured to transmit time synchronization information 308a-308d at regular time points 310, e.g. with a regular transmission interval 312, as discussed in relation to FIG. 1A to FIG. 1C. In this scenario, the follower device 212 may receive time synchronization information 308a-308d at approximately regular time intervals (e.g., possibly with slight variations due to a varying latency of the network). The processor 202 may be configured to define the duration of the time synchronization interval to be greater than the predefined transmission interval 312, e.g. at least two times greater, e.g. at least five times greater, so as to ensure taking into account for a varying delay through the network. As a numerical example, the predefined transmission interval 312 may have a time duration of less than 5 seconds, for example less than 2 seconds, for example 1 second, for example 100 milliseconds. The time synchronization interval 302 may have a duration in the range from 200 milliseconds to 10 seconds, for example in the range from 500 milliseconds to 2 seconds, as numerical examples.

FIG. 4 shows an exemplary determination 400 of whether a drift of a follower clock with respect to a leader clock is less than a predefined drift threshold (e.g., of whether the clock drift is within a predefined range), in a schematic representation according to the present disclosure.

In general, there may be various approaches to decide whether to proceed further with an update of the follower clock based on historical data. For example, the processor 202 may be configured to implement a machine learning model providing as input data network information and/or device information and/or clock information, and obtaining, as output, an indication on whether the processor 202 may instruct the update 224 of the follower clock 218 in absence of (actual) time synchronization information 216. As an example, the machine learning model may include a neural network. FIG. 4 illustrates an exemplary approach, which enables a simple and rapid, yet accurate decision process for determining whether proceed further with the update of the follower clock.

In an exemplary configuration, the processor 202 may be configured to determine whether the clock drift 222 of the follower clock 218 with respect to the leader clock 220 is less than the predefined drift threshold 406 (e.g., is within the predefined range 404) based on a plurality of previous drift values 402 (e.g., first to N-th drift values 402-1 to 402-N). Each drift value 402 may correspond to respective time synchronization information previously (successfully) received at the follower device 212. Illustratively, each drift value 402 may correspond to previous clock drifts of the follower clock 218 with respect to the leader clock 220 prior to the failed reception of the (new) time synchronization information 216. For example, each drift value 402 may be associated with a corresponding time synchronization message, e.g. a corresponding time synchronization packet, previously received at the follower device 212.

Each drift value 402 may be representative of a clock drift prior to the update instructed by the corresponding time synchronization information. Illustratively, each drift value 402 may represent the difference between one or more clock parameters of the follower clock 218 with respect to corresponding one or more clock parameters of the leader clock 220 as determined (e.g., as calculated) for a respective previous adjustment of the follower clock.

As an example, each drift value 402 may be or represent a difference between the clock value of the follower clock 218 and the clock value of the leader clock 220 prior to the update instructed by the corresponding time synchronization information. Drifts of the clock value have been found to provide a straightforward, yet reliable assessment of the feasibility of instructing an update of the follower clock 218 in absence of time synchronization information from the leader device. However, the drift values 402 may also represent, additionally or alternatively, other clock parameters. As another example, each drift value 402 may be or represent a difference between the clock rate of the follower clock 218 and the clock rate of the leader clock 220 prior to the update instructed by the corresponding time synchronization information. As a further example, each drift value 402 may be or represent a difference between the clock phase of the clock signal of the follower clock 218 and the clock phase of the clock signal of the leader clock 220 prior to the update instructed by the corresponding time synchronization information. In an exemplary configuration, the drift values 402 may be or include a sequence of drift values corresponding to time synchronization information consecutively received at the follower device 212, e.g. consecutive time synchronization messages, e.g. consecutive time synchronization packets.

By way of illustration, the plurality of (previous) drift values 402 may allow obtaining an understanding of a behavior over time of the follower clock 218 with respect to the leader clock 220, which thus allows determining whether it may be expected that the clock drift 222 (illustratively, the clock drift 222 at the current instance, in absence of time synchronization information) is less than the predefined drift threshold 406 (e.g., is within the predefined range 404).

In general, the processor 202 may be configured to determine whether the clock drift 222 is less than the predefined drift threshold 406 (e.g., whether the clock drift 222 is within the predefined range 404) based on the plurality of drift values 402. Illustratively, the processor 202 may be configured to decide (e.g., to predict) whether the clock drift 222 is within an acceptance range based on historical information about the clock drifts of the follower clock 218 with respect to the leader clock 220.

There may be various possibilities for the decision-making process based on the drift values 402. As an example, the processor 202 may be configured to determine that the clock drift 222 is within the predefined range 404 in the case that each drift value 402 is within the predefined range 404, e.g. the processor 202 may be configured to determine that the clock drift 222 is less than the predefined drift threshold 406 in the case that each drift value 402 is less than the predefined drift threshold 406. Illustratively, the processor 202 may be configured to determine that the clock drift 222 is sufficiently low to allow carrying out an update of the follower clock 218 if in the previous instances the clock drifts were sufficiently low. This evaluation may provide determining with a suitable level of confidence that the follower clock 218 substantially follows the behavior of the leader clock 220, so that it may be assumed that the deviation is not excessive and an update may be carried out even without having received updated time synchronization information 216.

The predefined range 404 and the predefined drift threshold 406 may be representative of one or more clock parameters, depending on the parameter(s) selected for the evaluation. For example, the predefined range may be a range for the drift of the clock value. As another example, the predefined range may be a range for the drift of the clock rate. As a further example, the predefined range may be a range for the drift of the clock phase. In an exemplary configuration, the predefined range may include a plurality of ranges, e.g. one for each clock parameter to be considered. In a corresponding manner, the predefined drift threshold 406 may include a plurality of threshold values, e.g. one for each clock parameter to be considered.

The predefined range (or the predefined drift threshold) as well as the number of previous drift values 402 considered for the evaluation may be freely selected as long as the behavior of the follower clock 218 may be reliably evaluated. As a numerical example, which has been found to provide a sufficient level of confidence for the process described herein, the plurality of drift values 402 may include at least ten drift values 402, e.g. at least fifteen drift values 402, e.g. at least twenty drift values 402.

The predefined drift threshold 406 may be selected according to a desired accuracy for the overall synchronization of the network. For example, the predefined drift threshold 406 (e.g., an upper limit of the predefined drift range 404) may be double digit with a nanosecond resolution. Such value has been found to provide sufficient synchronization to ensure continuity in a network associated with time-critical operations. As exemplary numerical values, the predefined drift threshold may be less than 100 ns, e.g. the predefined drift threshold may be in the range from 5 ns to 50 ns, for example in the range from 10 ns to 20 ns. For example, the predefined drift threshold may be 90 ns, or 50 ns, or 10 ns.

In an exemplary configuration, which has been found to provide a more reliable evaluation of the clock drift of the follower clock 218 with respect to the leader clock 220, the drift values 402 may include or represent root mean square (rms) values of the one or more clock parameters. In particular, each drift value may be or include the root mean square of the clock value of the follower clock 218 and the clock value of the leader clock 220 (illustratively, prior to the corresponding update instructed/cause by the corresponding time synchronization information). As another example, additionally or alternatively, each drift value may be or include the root mean square of the clock rate of the follower clock 218 and the clock rate of the leader clock 220. As a further example, additionally or alternatively, each drift value may be or include the root mean square of the clock phase of the clock signal of the follower clock 218 and the clock phase of the clock signal of the leader clock 220.

The root mean square may provide a direct, yet precise indication of whether the clock drift 222 may be suitable for the independent update of the follower clock 218. For example, the processor 202 may be configured to determine that the clock drift 222 (of the present instance) is less than the predefined drift threshold 406 (e.g., is within the predefined range 404) in the case that each root mean square is a single digit number.

In an exemplary configuration, a more flexible and adaptable evaluation may be provided. In this scenario, the plurality of drift values 402 may include (e.g., may be represented as) an exponential average with a suitably tuned alpha parameter. This approach allows dynamically deciding to which drift values should be given more significance, e.g. the historical values or the current instance. The processor 202 may thus be configured to carry out an exponential weighted moving average (EMA) on the drift values 402 to determine whether to proceed with the update 224 of the follower clock 218.

The processor 202 may be configured to determine (e.g., to calculate) a parameter F(t) as

F(t)=αF(t−1)+(1−α) I(t), (1)

where F(t) may represent the averaged rms drift, α is the weighted parameter between 0 and 1, F(t−1) is the averaged rms drift of the previous instance, and I(t) is the rms of the current instance. Illustratively, alpha is a smoothing factor, to decide to which values should be given more weight in the evaluation, either the previous instance (at t−1) or the current instance.

The processor 202 may be configured to determine whether the clock drift 222 is within the predefined range 404 based on F(t), e.g. based on whether a value of F(t) is less than the predefined drift threshold should be lesser then the threshold. The parameter alpha may be dynamically adapted, e.g. depending on a network scenario, depending on synchronization requirements of a certain operation, etc.

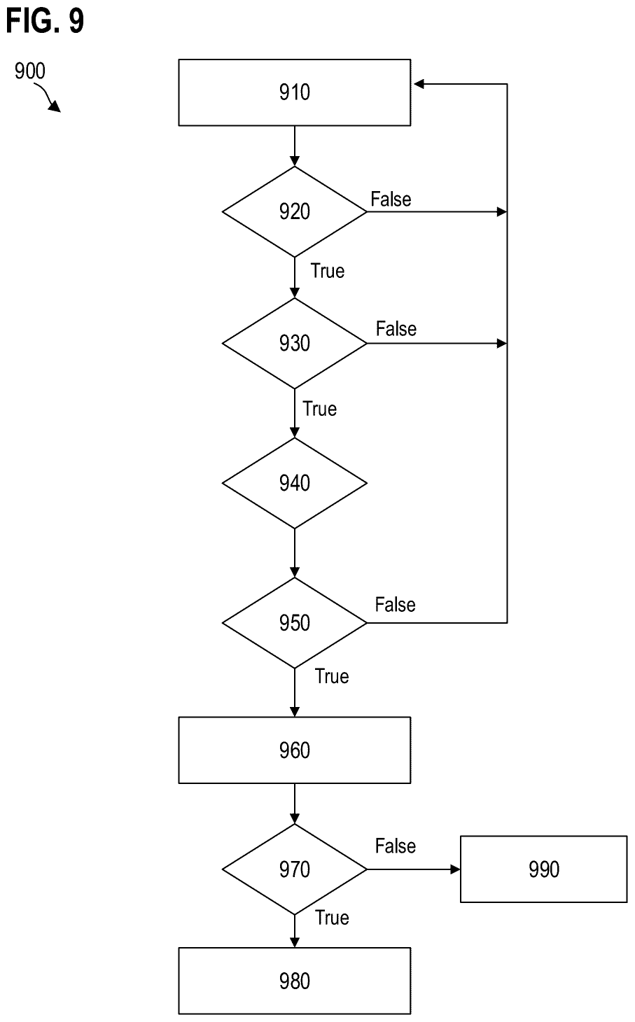

In an exemplary configuration (see also FIG. 9), the processor 202 may be configured to update a flag variable for each reception of time synchronization information. The flag variable may be representative of whether the clock drift for that time synchronization information (illustratively, the clock drift prior to the corresponding update) is less than the predefined drift threshold 406. The processor 202 may thus be configured to set the flag variable at a first value (e.g., “true”), if the clock drift is less than the predefined drift threshold 406, and to set the flag variable at a second value (e.g., “false”), if the clock drift is greater than the predefined drift threshold 406.

In a more complex, yet more accurate configuration, the processor 202 may be configured to set the flag variable based on the clock drift at the current instance and based on the previous clock drifts (e.g., according to the moving average described above). For example, the processor 202 may be configured to set (or maintain) the flag variable at the first value if the current clock drift and each previous clock drift of a plurality of previous clock drifts (e.g., the previous 10 clock drifts) are less than the predefined drift threshold. The processor 202 may be configured to set (or maintain) the flag variable at the second value if the current clock drift or at least one previous clock drift of a plurality of previous clock drifts (e.g., the previous 10 clock drifts) is greater than the predefined drift threshold.

In the scenario with a flag variable, the processor 202 may be configured to determine whether the clock drift 222 is less than the predefined drift threshold (e.g., in the predefined range) based on the flag variable. Illustratively, the processor 202 may be configured to determine that the clock drift 222 is less than the predefined drift threshold in the case that the flag variable has the first value (illustratively, a value, or a state, representing that over time the clock drift remained less than the predefined drift threshold). Correspondingly, the processor 202 may be configured to determine that the clock drift 222 is greater than the predefined drift threshold in the case that the flag variable has the second value (illustratively, a value, or a state, representing that over time the clock drift did not remain sufficiently below the predefined drift threshold).

In an exemplary configuration, the flag variable may also provide deciding whether to initiate the (self) synchronization process. Illustratively, the processor 202 may be configured to monitor the reception of time synchronization information if the flag variable has the first value, illustratively if the flag variable indicates that it would be possible to synchronize the follower clock 218 even in absence of time synchronization information. The processor 202 may be configured to refrain from monitoring the reception of time synchronization information if the flag variable has the second value. This configuration may provide saving computational resources if the self-synchronization of the follower clock may not be carried out in the present scenario.

FIG. 5 shows an exemplary update 500 of the clock of the follower device, in a schematic representation according to the present disclosure.

In general, to update the follower clock 218, the processor 202 may be configured to determine (e.g., to define) one or more new clock parameters (e.g., a set of clock parameters) according to which the follower clock 218 may operate. Illustratively, the processor 202 may be configured to define new clock parameters and may be configured to instruct the follower clock 218 to adapt (e.g., to match) its current clock parameters to the newly defined clock parameters.

As mentioned in relation to FIG. 1A to FIG. 1C, the update 224 of the follower clock 218 may be based on historical data, e.g. on previous time synchronization information successfully received at the follower device 212. In general, there may be various approaches to determine the next update based on previous information, e.g. based on previous updates. For example, the processor 202 may be configured to implement a machine learning model (e.g., including a neural network) to derive how to instruct the next update of the follower clock 218 based on input data representing previous information, e.g. representing previous updates. In other configurations, discussed in further detail below, the processor 202 may use simpler and more readily implementable techniques for instructing the update 224.

In an exemplary configuration, as shown in FIG. 5, the processor 202 may be configured to determine a plurality of previous update values 502 (e.g., first to N-th update values 502-1 to 502-N) and may be configured to instruct the update 224 based on the plurality of previous update values 502, e.g. using the previous update values 502. Each update value 502 may correspond to respective time synchronization information previously (successfully) received at the follower device 212. Illustratively, each update value 502 may correspond to previous updates of the follower clock 218 to synchronize with the leader clock 220 prior to the failed reception of the (new) time synchronization information 216. For example, each update value 502 may be associated with a corresponding time synchronization message, e.g. a corresponding time synchronization packet, previously received at the follower device 212. In an exemplary configuration, the update values 502 may be or include a sequence of update values corresponding to time synchronization information consecutively received at the follower device 212, e.g. consecutive time synchronization messages, e.g. consecutive time synchronization packets.

Each update value 502 may be representative of an update of one or more clock parameters of the follower clock 218 as instructed (e.g., as caused) by the corresponding time synchronization information. As an example, an update value 502 may be representative of an update of the clock value of the follower clock 218, e.g. an update value 502 may include or represent an adjustment value to modify the clock value of the follower clock 218 to synchronize with the clock value of the leader clock 220. As another example, additionally or alternatively, an update value 502 may be representative of an update of the clock rate of the follower clock 218, e.g. an update value 502 may include or represent an adjustment value to modify the clock rate of the follower clock 218 to synchronize with the clock rate of the leader clock 220. Further clock parameters may also be considered, as discussed above. As a further example, additionally or alternatively, an update value 502 may be representative of an update of the clock phase of the clock signal of the follower clock 218, e.g. an update value 502 may include or represent an adjustment value to modify the clock phase of the clock signal of the follower clock 218 to synchronize with the clock phase of the clock signal of the leader clock 220.

The processor 202 may be configured to define (e.g., to calculate) an update value 504 for updating the follower clock 218 based on the plurality of previous update values 502. Illustratively, the processor 202 may be configured to determine an update value 504 for instructing the (next) update 224 of the follower clock 218 by deriving the (next) update value 504 from the known previous update values 502. The update value 504 may represent an update of one or more clock parameters, depending on the desired application (e.g., depending on which parameters are relevant for the operation carried out by the follower device 212). For example, the update value 504 for instructing the next update 224 may include or represent an update of the clock value and/or of the clock rate of the follower clock 218, e.g. the update value 504 may include an adjustment value for modifying the clock value of the follower clock 218 and/or an adjustment value for modifying the clock rate of the follower clock 218. As a further example, the update value 504 for instructing the next update 224 may include or represent an update of the clock phase of the clock signal of the follower clock 218, e.g. the update value 504 may include an adjustment value for modifying the clock phase.

The processor 202 may be configured to extrapolate the update value 504 from the plurality or previous update values 502. In general, any suitable extrapolation method may be applied to derive the next update value 504 from the historic sequence of update values 502. As exemplary extrapolation techniques, which have been found to provide a suitable and efficient extrapolation of the update value 504 for instructing the update 224, the processor 202 may be configured to extrapolate the update value 504 using a time series auto regression method, and/or an online polynomial fit regression, and/or an exponential average. In a simpler configuration, the processor 202 may be configured to extrapolate the update value 504 using a linear extrapolation of the previous update values.

The number of previous update values 502 considered in the definition of the next update value 504 may be freely selected, as long as an accurate operation of the network is ensured. As a numerical example, which has been found to allow maintaining synchronization to the leader clock 220 with sufficient accuracy, the previous update values 502 may include at least ten update values 502, e.g. at least fifteen update values 502, e.g. at least twenty update values 502.

In an exemplary configuration, the processor 202 may be further configure to use the defined (e.g., extrapolated) update value 504 to update the clock parameter(s) of the follower clock 218. Illustratively, the processor 202 may transmit an instruction signal including the update value 504 to the follower device 212. Further illustratively, after the instructing of the update 224, and after the carrying out of the update 224 at the follower device 212, the follower clock 218 may have clock parameter(s) modified according to the update value 504, e.g. a modified clock value, a modified clock rate, and/or a modified clock phase, as examples.

FIG. 6 shows an exemplary instructing of an update of the follower clock during a self-synchronization interval 602, in a schematic representation according to the present disclosure.

In an exemplary configuration, the synchronization of the follower clock 218 without receiving updated time synchronization information from the leader device 214 may be carried out for a predefined period of time 602. Such predefined period of time may be a self-synchronization interval 602, e.g. a time interval during which it may be assumed that the follower clock 218 may remain substantially synchronized to the leader clock 220 even in absence of updated time synchronization information.

The processor 202 may thus be configured to continue instructing the update 224 of the clock 218 of the follower device 212 for the predefined period of time 602. During the self-synchronization interval 602, the processor 202 may illustratively be configured to determine (e.g., define) one or more update values, e.g. a plurality of update values (e.g., first to N-th update values 604-1 to 604-N), and may be configured to instruct one or more updates of the follower device 212 using the one or more update values.

For example, the processor 202 may be configured to instruct a further update at predefined time intervals during the self-synchronization interval 602, e.g. the processor 202 may be configured to determine an update value 604-1, . . . ,604-N at a respective time point 606-1, . . . ,606-N and use the update value 604-1, . . . ,604-N to instruct (e.g., cause) a corresponding adjustment of the clock parameter(s) of the follower clock 218.

The duration of the self-synchronization interval 602 may be freely selected depending on a desired tradeoff between the accuracy for the overall synchronization of the network and a continuity of the operation of the network. Illustratively, a longer self-synchronization interval 602 may lead to an overall worse synchronization (due to the longer period of time of updating the follower clock 218 without receiving updated information), but may allow continuing to carry out a certain operation for a longer time.

As an exemplary configuration, the processor 202 may be configured to define the predefined period of time 602 based on a predefined time boundary proportional to the duration of the time synchronization interval 302. Illustratively, the processor 202 may be configured to select a duration for the self-synchronization interval based on the duration of the time synchronization interval 302 during which the failed reception of the time synchronization information at the follower device 212 occurred. As a numerical example, the self-synchronization interval 602 may have a duration that is greater than the duration of the time synchronization interval, e.g. at least two times greater, e.g. at least five times greater.

A simple, yet efficient implementation of defining a duration for the self-synchronization process may include a back-off timer. In this scenario, the processor 202 may be configured to initiate a back-off timer starting from the predefined time boundary. The predefined time boundary may have an initial value corresponding to the duration of the self-synchronization interval 602, and may decrease to a predefined value (e.g., zero) to indicate the elapsing of the self-synchronization interval 602. It is understood that other options may be provided to monitor the self-synchronization interval 602, e.g. a timer moving forward in time, as another example.

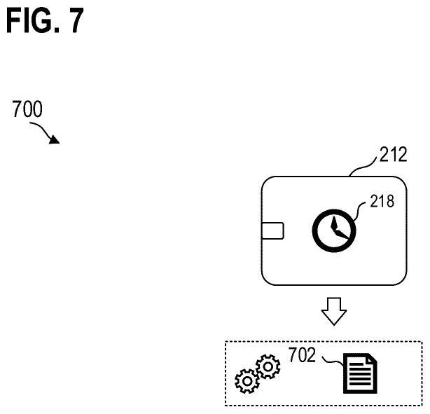

In general, the processor 202 may be configured to stop instructing the update 224 of the clock 218 of the follower device 212 in the case that the predefined period of time 602 has elapsed (e.g., in the case that the back-off timer has expired). Illustratively, the self-synchronization interval 602 may be a maximum time during which the follower clock 218 may be updated without receiving information about the leader clock 220. After this time has elapsed, it may be safer to interrupt the self-synchronization (and in general an operation of the follower device, as discussed in FIG. 7), and wait for a re-establishment of the communication link with the leader device 214.

The duration of the self-synchronization interval 602 (e.g., the time boundary defining the initial value of the back-off timer) may be dynamically adapted, so that in the case that a further loss of time synchronization information occurs, the self-synchronization interval 602 may have an adapted duration to take into account the network scenario.

In an exemplary configuration, the processor 202 may be configured to modify a value of the predefined time boundary in the case that the time synchronization information 216 is received at the follower device 212 during the predefined time period 602. Illustratively, if the delivery/reception of the time synchronization information 216 (or, in general, of further time synchronization information) succeeds during the self-synchronization interval 602, the newly received time synchronization information may be used for further updating the follower clock 218, and the predefined time boundary may be modified accordingly. Illustratively, the predefined time boundary may be modified to take into account a time delay at which the time synchronization information has been received with respect to the start of the time-synchronization interval. This dynamic adaptation may ensure optimizing the self-synchronization process to the overall properties of the network (e.g., latency, residence times, etc.).

For example, the processor 202 may be configured to modify the value of the predefined time boundary by reducing such value by an amount proportional to the time elapsed from the beginning of the predefined time period 602 to the time at which the follower device received the (previously missing) time synchronization information. As an exemplary formula for modifying the predefined time boundary, the processor 202 may be configured to modify the predefined time boundary (PTB) as,

PTB=min(Avg(HopCount*(RTT of last hop/2)),Avg(Network recovery time)); (2)

where HopCount indicates the number of hops between the leader device 214 and the follower device 212, and RTT of last hop indicates the round-trip time of the last hop to the follower device 212 (illustratively, the hop between the follower device 212 and the immediately preceding node).

The processor 202 may be configured to use the modified value of the predefined time boundary in case of a further failed reception of further time synchronization information at the follower device 212. For example, the processor 202 may be configured to store the modified value, e.g. in the memory 204 of the device 200 (e.g., in a non-transitory storage medium, e.g. in a non-volatile storage medium), and retrieve the modified value for a further self-synchronization process.

FIG. 7 shows an exemplary processing 700 of information at the follower device, in a schematic representation according to the present disclosure.

In general, the updating of the follower clock 218 independently of time synchronization information of the leader clock 220 enables the follower device 212 to continue operating (e.g., at least during the self-synchronization interval 602). Illustratively, the follower device 212 may be configured to operate using the clock 218 as updated according to the update 224 instructed by the processor 202.

In an exemplary configuration, the processor 202 may be configured to instruct the follower device 212 to process control information 702. For example, a processor of the follower device 212 may process the control information 702. In another configuration, the processor of the follower device 212 may be configured to process the control information 702 without input from the processor 202. For example the leader device 214 may transmit the control information 702 to the follower device 212. In another scenario, the control information 702 may include predefined instructions stored in the memory of the follower device 212. In an exemplary configuration, the control information 702 may be or include time-critical instructions, e.g. the control information 702 may represent instructions of a time-critical operation that the follower device 212 may carry out.

The control information 702 may include or represent instructions to control an operation of the follower device 212. Illustratively, the control information 702 may include or represent instructions for one or more actions that the follower device 212 may execute. According to the strategy described herein, the follower device 212 may be configured to process the control information 702 using the updated follower clock 218. This may thus ensure operational continuity in the network.

As mentioned in relation to FIG. 2, the processor 202 may be configured to instruct the update 224 of the follower clock 218 if the clock drift 222 is less than the predefined drift threshold (e.g., in case the clock drift 222 is within the predefined range). In the other scenario in which the clock drift 222 is greater than the predefined drift threshold/outside the predefined range (e.g., in case at least one drift value 502 is outside the range, e.g. in case at least one drift value 502 is greater than the predefined drift threshold), the processor 202 may be configured to instruct the follower device 212 to stop processing control information 702. In this scenario, the follower device 212 may stop operating and may enter into a waiting mode for re-establishing a synchronization with the leader clock 220, e.g. upon receiving updated time synchronization information.

As another possibility, additionally or alternatively, the processor 202 may be configured to instruct the follower device 212 to stop processing control information 702 in the case that the update 224 of the follower clock 218 has been stopped. Illustratively, the follower device 212 may stop processing control information 702 after the end of the self-synchronization interval 602, e.g. after the expiry of the back-off timer.

FIG. 8 shows an exemplary communication network 800 including a grandmaster clock and an ordinary clock, in a schematic representation according to the present disclosure. Illustratively, FIG. 8 shows an exemplary application scenario of the strategy described in relation to FIG. 2 to FIG. 7.

The communication network 800 may include a leader device 802 (e.g., a grandmaster device of the communication network 800) and a follower device 806. In an exemplary configuration, the leader device 802 may be a first machine (machine A), and the follower device 806 may be a second machine (machine B). The communication network 800 may further include a switch 804 (illustratively, a bridge) interposed between the leader device 802 and the leader device 802. The switch 804 may be, for example, a transparent clock, or a boundary clock.

The leader device 802 may include a system clock 808 and a hardware clock 810. The hardware clock 810 may be, for example, a PTP clock. In a corresponding manner, the follower device 806 may include a system clock 814 and a hardware clock 812. The hardware clock 812 may be, for example, a PTP clock.

For synchronizing the hardware clock 812 of the follower device 806 to the hardware clock 810 of the leader device 802, the leader device 802 may transmit time synchronization information, e.g. a time synchronization packet, such as a gPTP packet. In a first step, a egress port 816 of the leader device 802 may assume a leader role (e.g., a master role) and an ingress port 818 of the switch 804 may assume a follower role (e.g., a slave role), so that a clock 820 of the switch 804 may synchronize to the leader hardware clock 810.

In a second step, an egress port 822 of the switch 804 may assume a leader role and an ingress port 824 of the follower device 806 may assume a follower role, so that the follower hardware clock 812 may synchronize to the clock 820 of the switch 804 (and accordingly to the leader hardware clock 810). Illustratively, the transfer of information from the switch 804 to the follower device 806 should enable an adjustment of the PTP hardware clock 812 (PHC) and accordingly an adjustment of the system clock 814 with the PTP hardware clock 812.

In case of a failed reception of information at the follower device 806, e.g. in case of a disrupted communication link between the switch 804 and the follower device 806, a processor 826 of the follower device may be configured to carry out a self-synchronization procedure 830 (e.g., according to the method 210 described in relation to FIG. 2 to FIG. 7).

In a normal operation state, 832, the processor 826 of the follower device 806 (e.g., a user equipment) may be configured to calculate the clock drift and adjust the hardware clock 812 and system clock 814 based on the received information (e.g., based on the received gPTP packet(s)). If a loss of time synchronization information is detected, 834, e.g. a gPTP packet loss, then the processor 826 may be configured to check, 836, if the drift is within a permissible boundary (e.g., a single digit), and may be configured to start a dynamic back-off timer. During the self-synchronization interval, the processor 826 may be configured, 838, to extrapolate the time synchronization (e.g., based on a suitable extrapolation technique) and to continue adjusting the hardware clock 812 and system clock 814 until the back-off timer expires.

FIG. 9 shows an exemplary flow diagram of a method 900 of operating a communication network according to the present disclosure. The method 900 may be an exemplary configuration of the method 210, e.g. the method 900 may include various aspects described in relation to FIG. 2 to FIG. 7. For example, the method 900 may be running in the follower device (illustratively, in the follower node).

The method 900 may include, in 910, monitoring the reception of time synchronization information, and monitoring the clock drift of a follower clock with respect to a leader clock. The monitoring in 910 may be a triggering condition for starting the self-synchronization, e.g. in case a failed reception of time synchronization information is detected and in case the clock drift is less than the predefined drift threshold (e.g., in case the clock drift is within the predefined range). In an exemplary configuration, the monitoring in 910 may include monitoring for gPTP packets at defined regular X intervals, and monitoring the calculated rms for at least ten previous time synchronization packets received at the regular X intervals. An X interval may be a minimum regular interval for time synchronization, for example 1 second.

The method 900 may include, in 920, determining whether the clock drift is less than the predefined threshold, e.g. whether the clock drift is in the predefined range. For example, the determining in 920 may include determining whether the rms is a single digit. If the clock drift is less than the predefined drift threshold/is in the predefined range (true in 920), the method 900 may move to 930 where the method 900 may include setting a flag variable (Y) to True. In an exemplary configuration, the flag variable Y may be True if the rms is single digit for a minimum of ten continuous previous time synchronization packets received at the regular X intervals. If the clock drift is greater than the predefined drift threshold/is outside the predefined range (false in 920), the method 900 may go back to 910, and start monitoring again the drift and the reception of information. In this case the flag variable Y may be set to False, so that the self-synchronization process would not proceed further. Illustratively, the flag variable Y may be False if the rms is more than a single digit in any of the 10 previous time sync packets received at regular X intervals.

If the flag variable Y is True, the method 900 may proceed to 940 whether the method 900 may include determining whether time synchronization information was not received during a time synchronization interval. In an exemplary configuration, the method 900 may include detecting whether a gPTP packet was not received at a Z interval, where the Z interval may represent the minimum continuous time sync interval where the gPTP sync packets were not received from the leader at follower clock. The duration of the Z interval may be a multiple of the duration of the X interval.

If the time synchronization interval (e.g., the Z interval) has elapsed without the follower device receiving time synchronization information, the method 900 may move to checking, in 950, the value of the flag variable Y. If the flag variable Y is False, the method 900 may go back to 910. If the flag variable Y is True, the method 900 may move to 960 and start instructing the update of the follower clock for a duration of a self-synchronization interval. For example, the method 900 may include, in 960, starting a back-off timer (e.g., using a dynamically calculated initial value).

The method 900 may further include, in 970, determining whether the self-synchronization interval has elapsed before the follower device received updated time synchronization information from the leader device. For example, the method 900 may include determining whether the timer has expired before the follower device received the next gPTP sync packet.

If the self-synchronization interval has elapsed (True in 970), the method 900 may include, in 980 stopping the self-synchronization and stopping the processing of control information (e.g., the processing of control packets).

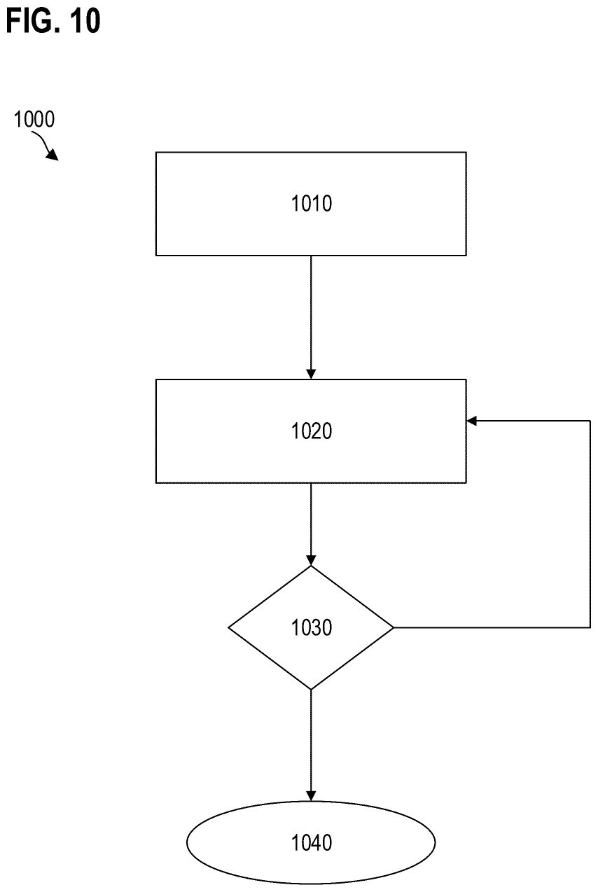

If the self-synchronization interval was still running when the follower device received updated time synchronization information, the method 900 may include, in 990, updating the duration of the self-synchronization interval (e.g., updating the time boundary of the timer). For example, the method 900 may include feeding the difference (back-off timer start−back-off timer end) to a feedback algorithm (see FIG. 10) for calculating the new boundary value.

FIG. 10 shows an exemplary flow diagram of a method 1000 of operating a back-off timer according to the present disclosure. In general, FIG. 10 illustrates a clock drift (e.g., a gPTP data drift) and back-off timer mechanism. In case the timer expires, the follower device will stop the time synchronization and may disconnect. This may provide achieving critical time synchronization. Illustratively, the processor of the follower device may carry out the method 1000.

The method 1000 may include, in 1010, determining whether the clock drift (illustratively, the drift values) between the leader clock and follower clock is stable (e.g., single digit). In an exemplary configuration, the clock drift may be a gPTP sync data drift.

The method 1000 may further include, in 1020, starting a fault detection algorithm to detect loss of time synchronization information (e.g., loss of gPTP packets), e.g. based on whether the follower device received or not updated information during a time synchronization interval.

The method 1000 may further include, in 1030, determining whether the back-off timer expired before receiving updated information from the leader device. If time synchronization information is received (e.g., a gPTP packet is received) before the expiration of the back-off timer, the method 1000 may go back to 1020 and continue monitoring the reception of time synchronization information. If time synchronization information is not received before the expiration of the back-off timer, the method 1000 may move to 1040 and may include disconnecting the follower device.

As an exemplary configuration, initially the back-off timer (BT) may be set to 2*Z, which is double the minimum continuous time sync interval where time synchronization information (e.g., the gPTP sync packets) were not received. In case time synchronization information (e.g., gPTP packet) is received before the timer expires, the BT timer may reduced by the positive feedback mechanism (e.g., according to Equation 2 described above). In case the timer expires the follower device will stop the time-sync and is disconnected.

The strategy described in the present disclosure may thus be based on detecting the loss of time synchronization information (e.g., the loss of gPTP packets) and on detecting if drift may be utilized for extrapolating the time sync information (e.g., using an extrapolation technique, such as a linear extrapolation technique) and continue to synchronize the clock (e.g., system and hardware clock) of the follower device, e.g. until a back-off timer is expired. This approach will avoid the computation power loss where time synchronization is re-initiated during the re-establishment. This will also ensure that time-critical information will proceed. The approach described herein may be scaled to M-RAT (Multi Radio Access Technology) for time-sensitive use cases. Illustratively, the technology described herein may support TSN over M-RAT. The approach may provide advantages for TSN-enabled IOT platforms and time critical applications, and may be scaled to use-cases like Industry 4.0, power grid, mobile robots, pro AV, and any time critical scenarios.

In the following, various examples are provided that refer to aspects of the present disclosure.

Example 1 is a device including a processor configured to: detect a failed reception of time synchronization information at a follower device, the time synchronization information being configured to instruct an update of a clock of the follower device for synchronization to a clock of a leader device; determine, e.g. upon detecting the failed reception of the time synchronization information, whether a clock drift between the clock of the follower device and the clock of the leader device is less than a predefined drift threshold (e.g., is within a predefined range); and in the case that the clock drift is less than the predefined drift threshold (e.g., is within the predefined range), instruct an update of the clock of the follower device based on time synchronization information previously received at the follower device.

As an example, the leader device may be a grandmaster device (illustratively, a grandmaster clock) of the communication network.

In Example 2, the device of example 1 may optionally further include that the update of the clock of the follower device for synchronization to the clock of the leader device includes an update of a clock value of the clock of the follower device for synchronization to a clock value of the clock of the leader device and/or an update of a clock rate of the clock of the follower device for synchronization to a clock rate of the clock of the leader device.

In Example 3, the device of example 1 or 2 may optionally further include that the processor is configured to detect the failed reception of time synchronization information by detecting a failed reception of a time synchronization packet at the follower device.

In Example 4, the device of example 3 may optionally further include that the time synchronization packet is or includes a generic Precision Time Protocol (gPTP) packet.

In Example 5, the device of any one of examples 1 to 4 may optionally further include that the clock drift between the clock of the follower device and the clock of the leader device includes a drift of a clock value of the clock of the follower device with respect to a clock value of the clock of the leader device and/or a drift of a clock rate of the clock of the follower device with respect to a clock rate of the clock of the leader device.

In Example 6, the device of any one of examples 1 to 5 may optionally further include that the processor is configured to detect the failed reception of time synchronization information at the follower device by determining that a time synchronization interval has elapsed without the follower device receiving time synchronization information during the time synchronization interval.

In Example 7, the device of example 6 may optionally further include that a duration of the time synchronization interval is a multiple of a predefined transmission interval at which the leader device is expected to transmit time synchronization information to the follower device.

In Example 8, the device of any one of examples 1 to 7 may optionally further include that the processor is configured to determine whether the clock drift between the clock of the follower device and the clock of the leader device is less than the predefined drift threshold (e.g., is within the predefined range) by determining a plurality of drift values each corresponding to previous time synchronization information received at the follower device prior to the failed reception of the time synchronization information, wherein each drift value is representative of a difference between a clock value of the clock of the follower device and a clock value of the clock of the leader device prior to the update instructed by the corresponding time synchronization information; and determining whether the clock drift between the clock of the follower device and the clock of the leader device is less than the predefined drift threshold (e.g., is within the predefined range) based on the plurality of drift values.

In Example 9, the device of example 8 may optionally further include that the processor is configured to determine that the clock drift between the clock of the follower device and the clock of the leader device is less than the predefined drift threshold (e.g., is within the predefined range) in the case that each drift value is less than the predefined drift threshold (e.g., in the case that each drift value is within the predefined range).

In Example 10, the device of example 8 or 9 may optionally further include that the processor is configured to determine that the clock drift between the clock of the follower device and the clock of the leader device is within the predefined range in the case that each drift value is less than the predefined drift threshold.

In Example 11, the device of example 10 may optionally further include that the predefined threshold is double digit with a nanosecond resolution. As a numerical example, the predefined drift threshold may be less than 100 ns, e.g. the predefined drift threshold may be 90 ns, or 50 ns, or 10 ns.

In Example 12, the device of any one of examples 8 to 11 may optionally further include that each drift value includes the root mean square of the clock value of the clock of the follower device and the clock value of the clock of the leader device prior to the corresponding update.

In Example 13, the device of example 12 may optionally further include that the processor is configured to determine that the clock drift between the clock of the follower device and the clock of the leader device is less than the predefined drift threshold (e.g., is within the predefined range) in the case that each root mean square is a single digit number.

In Example 14, the device of any one of examples 8 to 13 may optionally further include that the plurality of drift values correspond to consecutive time synchronization information (e.g., consecutive messages, e.g. consecutive time synchronization packets) received at the follower device.

In Example 15, the device of any one of examples 8 to 14 may optionally further include that the plurality of drift values includes an exponential average with a suitably tuned alpha parameter.

In Example 16, the device of any one of examples 1 to 15 may optionally further include that to instruct the update of the clock of the follower device based on time synchronization information previously received at the follower device the processor is configured to: determine a plurality of update values each corresponding to previous time synchronization information received at the follower device prior to the failed reception of the time synchronization information, and that each update value is representative of an update of the clock value of the clock of the follower device instructed by the corresponding time synchronization information and/or of an update of the clock rate of the clock of the follower device instructed by the corresponding time synchronization information; and define an update value for updating the clock value and/or the clock rate of the clock of the follower device based on the plurality of update values.

In Example 17, the device of example 16 may optionally further include that the processor is further configured to use the defined update value to update the clock value and/or the clock rate of the clock of the follower device.

In Example 18, the device of example 16 or 17 may optionally further include that the processor is configured to define the update value for updating the clock value and/or the clock rate of the clock of the follower device by extrapolating the update value from the plurality of update values.

In Example 19, the device of example 18 may optionally further include that to extrapolate the update value from the plurality of update values the processor is configured to carry out one of: a time series auto regression method, an online polynomial fit regression, and/or an exponential average. As a further example, the processor may be configured to carry out a linear extrapolation.

In Example 20, the device of any one of examples 16 to 19 may optionally further include that the plurality of update values correspond to consecutive time synchronization information (e.g., consecutive messages, e.g. consecutive time synchronization packets) received at the follower device.

In Example 21, the device of any one of examples 16 to 20 may optionally further include that the plurality of update values include at least ten update values.

In Example 22, the device of any one of examples 1 to 21 may optionally further include that the processor is configured to: continue instructing the update of the clock of the follower device for a predefined period of time; and stop instructing the update of the clock of the follower device in the case that the predefined period of time has elapsed.

In Example 23, the device of any one of examples 1 to 22 may optionally further include that the processor is configured to: instruct the follower device to stop processing control information in the case that the update of the clock of the follower device based on the previously received time synchronization information has been stopped.

In Example 24, the device of example 23 may optionally further include that the processor is configured to define the predefined period of time based on a predefined time boundary, and that the predefined time boundary is proportional to a duration of a time synchronization interval during which the failed reception of the time synchronization information at the follower device occurred.

In Example 25, the device of example 24 may optionally further include that the predefined time boundary is twice the duration of the time synchronization interval.

In Example 26, the device of example 24 or 25 may optionally further include that the processor is configured to define the predefined period of time based on a predefined time boundary by initiating a back-off timer starting from the predefined time boundary.

In Example 27, the device of example 26 may optionally further include that the processor is configured to stop instructing the update of the clock of the follower device in the case that the back-off timer has expired.

In Example 28, the device of any one of examples 24 to 27 may optionally further include that the processor is configured to modify a value of the predefined time boundary in the case that the time synchronization information is received at the follower device during the predefined time period. The modified value of the predefined time boundary may be for use in case of a further failed reception of further time synchronization information at the follower device.

In Example 29, the device of example 28 may optionally further include that the processor is configured to modify the value of the predefined time boundary by reducing the value of the predefined time boundary by an amount proportional to the time elapsed from the beginning of the predefined time period to the time at which the follower device received the time synchronization information.

In Example 30, the device of example 28 or 29 may optionally further include that the processor is configured to store the modified value of the predefined time boundary in a non-transitory memory device.

In Example 31, the device of any one of examples 1 to 30 may optionally further include that the processor is further configured to instruct the follower device to process control information instructing an operation of the follower device.

In Example 32, the device of example 31 may optionally further include that the processor is further configured to instruct the follower device to process the control information using the updated clock of the follower device.

In Example 33, the device of example 31 or 32 may optionally further include that the processor is further configured to instruct the follower device to stop processing control information in the case that the clock drift is greater than the predefined threshold (e.g., in case the clock drift is outside the predefined range).

In Example 34, the device of any one of examples 1 to 33 may optionally further include that the clock of the follower device includes a system clock and/or a hardware clock of the follower device.

In Example 35, the device of any one of examples 1 to 34 may optionally further include that the follower device and the leader device are TSN-enabled device.

In Example 36, the device of any one of examples 1 to 35 may optionally further include that the follower device and the leader device are part of a communication network configured according to the Time Sensitive Networking (TSN) standard.

Example 37 is a device including a processor configured to instruct an update of a clock of a follower device to continue processing time critical control information at the follower device in absence of time synchronization information from a leader device by using time synchronization information previously received at the follower device.

In Example 38, the device of example 37 may optionally further include one or more features of any one of examples 1 to 36.

Example 39 is a device including a processor configured to: detect a failed reception of time synchronization information at the device, the time synchronization information being configured to instruct an update of a clock of the device for synchronization to a clock of a leader device; determine, upon detecting the failed reception of the time synchronization information, whether a clock drift between the clock of the device and the clock of the leader device is less than a predefined drift threshold (e.g., in case the clock drift is within a predefined range); and in the case that the clock drift is less than the predefined threshold (e.g., in case the clock drift is within the predefined range), instruct an update of the clock of the device based on time synchronization information previously received at the device.

In Example 40, the device of example 39 may optionally further include one or more features of any one of examples 1 to 36.

Example 41 is a device including a processor configured to determine if a time synchronization at a follower device fails, wherein the time synchronization causes an update of a clock value of a clock of the follower device for synchronization to a further clock of another device; if it is determined that the time synchronization fails, determine whether a drift between the clock and the further clock is within a predefined range; and if it is determined that the drift is within the predefined range, update the clock value of the clock using time synchronization information previously received at the follower device.

In Example 42, the device of example 41 may optionally further include one or more features of any one of examples 1 to 36.

Example 43 is a device including processing means for: detecting a failed reception of time synchronization information at the device, the time synchronization information instructs an update of a clock of the device for synchronization to a clock of a leader device; determining, upon detecting the failed reception of the time synchronization information, whether a clock drift between the clock of the device and the clock of the leader device is within a predefined range; and in the case that the clock drift is within the predefined range, instructing an update of the clock of the device based on time synchronization information previously received at the device.

In Example 44, the device of example 43 may optionally further include one or more features of any one of examples 1 to 36.

Example 45 is a communication network, comprising: a leader device and a follower device, wherein the leader device is configured to transmit time synchronization information to the follower device, wherein the time synchronization information is configured to instruct an update of a clock of the follower device for synchronization to a clock of the leader device, wherein the follower device includes a processor configured to: detect a failed reception of time synchronization information at the follower device; determine, upon detecting the failed reception of the time synchronization information, whether a clock drift between the clock of the follower device and the clock of the leader device is within a predefined range; and in the case that the clock drift is within the predefined range, instruct an update of the clock of the follower device based on time synchronization information previously received at the follower device.

Example 46 is a method of operating a communication network, the method including: detecting a failed reception of time synchronization information at a follower device, the time synchronization information being configured to instruct an update of a clock of the follower device for synchronization to a clock of a leader device; determining, e.g. upon detecting the failed reception of the time synchronization information, whether a clock drift between the clock of the follower device and the clock of the leader device is less than a predefined threshold (e.g., whether the clock drift is within a predefined range); and in the case that the clock drift is less than the predefined threshold (e.g., in case the clock drift is within the predefined range), instructing an update of the clock of the follower device based on time synchronization information previously received at the follower device.

In Example 47, the method of example 46 may optionally further include that the update of the clock of the follower device for synchronization to the clock of the leader device includes an update of a clock value of the clock of the follower device for synchronization to a clock value of the clock of the leader device and/or an update of a clock rate of the clock of the follower device for synchronization to a clock rate of the clock of the leader device.

In Example 48, the method of example 46 or 47 may optionally further include that detecting the failed reception of time synchronization information includes detecting a failed reception of a time synchronization packet at the follower device.

In Example 49, the method of example 48 may optionally further include that the time synchronization packet is or includes a generic Precision Time Protocol (gPTP) packet.

In Example 50, the method of any one of examples 46 to 49 may optionally further include that the clock drift between the clock of the follower device and the clock of the leader device includes a drift of a clock value of the clock of the follower device with respect to a clock value of the clock of the leader device and/or a drift of a clock rate of the clock of the follower device with respect to a clock rate of the clock of the leader device.

In Example 51, the method of any one of examples 46 to 50 may optionally further include that detecting the failed reception of time synchronization information at the follower device includes determining that a time synchronization interval has elapsed without the follower device receiving time synchronization information during the time synchronization interval.

In Example 52, the method of example 51 may optionally further include that a duration of the time synchronization interval is a multiple of a predefined transmission interval at which the leader device is expected to transmit time synchronization information to the follower device.

In Example 53, the method of any one of examples 46 to 52 may optionally further include that determining whether the clock drift between the clock of the follower device and the clock of the leader device is less than the predefined threshold (e.g., is within the predefined range) includes determining a plurality of drift values each corresponding to previous time synchronization information received at the follower device prior to the failed reception of the time synchronization information, wherein each drift value is representative of a difference between a clock value of the clock of the follower device and a clock value of the clock of the leader device prior to the update instructed by the corresponding time synchronization information; and determining whether the clock drift between the clock of the follower device and the clock of the leader device is less than the predefined threshold (e.g., is within the predefined range) based on the plurality of drift values.

In Example 54, the method of example 53 may optionally further include determining that the clock drift between the clock of the follower device and the clock of the leader device is less than the predefined threshold in the case that each drift value is less than the predefined threshold (e.g., determining that the clock drift is within the predefined range in the case that each drift value is within a predefined drift range).

In Example 55, the method of example 53 or 54 may optionally further include determining that the clock drift between the clock of the follower device and the clock of the leader device is within the predefined range in the case that each drift value is less than a predefined drift threshold.

In Example 56, the method of example 55 may optionally further include that the predefined threshold is double digit with a nanosecond resolution. As a numerical example, the predefined drift threshold may be less than 100 ns, e.g. the predefined drift threshold may be 90 ns, or 50 ns, or 10 ns.

In Example 57, the method of any one of examples 53 to 56 may optionally further include that each drift value includes the root mean square of the clock value of the clock of the follower device and the clock value of the clock of the leader device prior to the corresponding update.

In Example 58, the method of example 57 may optionally further include determining that the clock drift between the clock of the follower device and the clock of the leader device is less than the predefined drift threshold (e.g., is within the predefined range) in the case that each root mean square is a single digit number.

In Example 59, the method of any one of examples 53 to 58 may optionally further include that the plurality of drift values correspond to consecutive time synchronization information (e.g., consecutive messages, e.g. consecutive time synchronization packets) received at the follower device.

In Example 60, the method of any one of examples 53 to 57 may optionally further include that the plurality of drift values includes an exponential average with a suitably tuned alpha parameter.

In Example 61, the method of any one of examples 46 to 60 may optionally further include that instructing the update of the clock of the follower device based on time synchronization information previously received at the follower device includes: determining a plurality of update values each corresponding to previous time synchronization information received at the follower device prior to the failed reception of the time synchronization information, and that each update value is representative of an update of the clock value of the clock of the follower device instructed by the corresponding time synchronization information and/or of an update of the clock rate of the clock of the follower device instructed by the corresponding time synchronization information; and defining an update value for updating the clock value and/or the clock rate of the clock of the follower device based on the plurality of update values.

In Example 62, the method of example 61 may optionally further include using the defined update value to update the clock value and/or the clock rate of the clock of the follower device.

In Example 63, the method of example 61 or 62 may optionally further include that defining the update value for updating the clock value and/or the clock rate of the clock of the follower device includes extrapolating the update value from the plurality of update values.

In Example 64, the method of example 63 may optionally further include that extrapolating the update value from the plurality of update values includes carrying out one of: a time series auto regression method, an online polynomial fit regression, and/or an exponential average. As a further example, the processor may be configured to carry out a linear extrapolation.

In Example 65, the method of any one of examples 61 to 63 may optionally further include that the plurality of update values correspond to consecutive time synchronization information (e.g., consecutive messages, e.g. consecutive time synchronization packets) received at the follower device.

In Example 66, the method of any one of examples 61 to 65 may optionally further include that the plurality of update values include at least ten update values.

In Example 67, the method of any one of examples 46 to 66 may optionally further include continuing to instruct the update of the clock of the follower device for a predefined period of time; and stopping to instruct the update of the clock of the follower device in the case that the predefined period of time has elapsed.

In Example 68, the method of any one of examples 46 to 67 may optionally further include instructing the follower device to stop processing control information in the case that the update of the clock of the follower device based on the previously received time synchronization information has been stopped.

In Example 69, the method of example 68 may optionally further include defining the predefined period of time based on a predefined time boundary, and that the predefined time boundary is proportional to a duration of a time synchronization interval during which the failed reception of the time synchronization information at the follower device occurred.

In Example 70, the method of example 69 may optionally further include that the predefined time boundary is twice the duration of the time synchronization interval.

In Example 71, the method of example 69 or 70 may optionally further include that defining the predefined period of time based on a predefined time boundary includes initiating a back-off timer starting from the predefined time boundary.

In Example 72, the method of example 71 may optionally further include stopping to instruct the update of the clock of the follower device in the case that the back-off timer has expired.

In Example 73, the method of any one of examples 70 to 72 may optionally further include modifying a value of the predefined time boundary in the case that the time synchronization information is received at the follower device during the predefined time period. The modified value of the predefined time boundary may be for use in case of a further failed reception of further time synchronization information at the follower device.

In Example 74, the method of example 73 may optionally further include that modifying the value of the predefined time boundary includes reducing the value of the predefined time boundary by an amount proportional to the time elapsed from the beginning of the predefined time period to the time at which the follower device received the time synchronization information.

In Example 75, the method of example 73 or 74 may optionally further include storing the modified value of the predefined time boundary in a non-transitory memory device.

In Example 76, the method of any one of examples 46 to 75 may optionally further include instructing the follower device to process control information instructing an operation of the follower device.

In Example 77, the method of example 76 may optionally further include instructing the follower device to process the control information using the updated clock of the follower device.

In Example 78, the method of example 76 or 77 may optionally further include instructing the follower device to stop processing control information in the case that the clock drift is outside the predefined range.

In Example 79, the method of any one of examples 46 to 78 may optionally further include that the clock of the follower device includes a system clock and/or a hardware clock of the follower device.

In Example 80, the method of any one of examples 46 to 79 may optionally further include that the follower device and the leader device are TSN-enabled device.

In Example 81, the method of any one of examples 46 to 80 may optionally further include that the follower device and the leader device are part of a communication network configured according to the Time Sensitive Networking (TSN) standard.

Example 82 is a non-transitory computer readable medium storing instructions which, when the program is executed by a computer, cause the computer to carry out the method of any one of examples 46 to 81.

Example 83 is a computer program product including instructions which, when the program is executed by a computer, cause the computer to carry out the method of any one of examples 46 to 81.

Example 84 is a method of operating a communication network, the method including: instructing an update of a clock of a follower device to continue processing time critical control information at the follower device in absence of time synchronization information from a leader device by using time synchronization information previously received at the follower device.

In Example 85, the method of example 84 may optionally further include one or more features of any one of examples 46 to 81.

Example 86 is a non-transitory computer readable medium storing instructions which, when the program is executed by a computer, cause the computer to carry out the method of example 84 or 85.

Example 87 is a computer program product including instructions which, when the program is executed by a computer, cause the computer to carry out the method of example 84 or 85.

Example 88 is a method of operating a communication network, the method including: determining if a time synchronization at a follower device fails, wherein the time synchronization causes an update of a clock value of a clock of the follower device for synchronization to a further clock of another device; if it is determined that the time synchronization fails, determine whether a drift between the clock and the further clock is within a predefined range; and if it is determined that the drift is within the predefined range, updating the clock value of the clock using time synchronization information previously received at the follower device.

In Example 89, the method of example 88 may optionally further include one or more features of any one of examples 46 to 81.

Example 90 is a non-transitory computer readable medium storing instructions which, when the program is executed by a computer, cause the computer to carry out the method of example 88 or 89.

Example 91 is a computer program product including instructions which, when the program is executed by a computer, cause the computer to carry out the method of example 88 or 89.

The term “data” as used herein, for example in relation to “time synchronization data”, may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as used herein may be understood as any kind of technological entity that allows handling of data. The data may be handled according to one or more specific functions that the processor may execute. Further, a processor as used herein may be understood as any kind of circuit, e.g., any kind of analog or digital circuit. A processor may thus be or include an analog circuit, digital circuit, mixed-signal circuit, logic circuit (e.g., a hard-wired logic circuit or a programmable logic circuit), microprocessor (for example a Complex Instruction Set Computer (CISC) processor or a Reduced Instruction Set Computer (RISC) processor), Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. A “processor” may also be a logic-implementing entity executing software, for example any kind of computer program, for example a computer program using a virtual machine code such as for example Java. A “processor” as used herein may also include any kind of cloud-based processing system that allows handling of data in a distributed manner, e.g. with a plurality of logic-implementing entities communicatively coupled with one another (e.g. over the internet) and each assigned to handling the data or part of the data. By way of illustration, an application running on a server and the server can also be a “processor”. Any other kind of implementation of the respective functions, which will be described below in further detail, may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The term “system” detailed herein may be understood as a set of interacting elements, the elements may be, by way of example and not of limitation, one or more physical components (e.g., processors, transmitters and/or receivers) and/or one or more digital components (e.g., code segments, instructions, protocols). Generally, the system may include one or more functions to be operated (also referred to as “operating functions”) of which each may be controlled for operating the whole system.

The term “memory” as used herein may be understood as a computer-readable medium (e.g., a non-transitory computer-readable medium), in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint, among others, or any combination thereof. Furthermore, it is appreciated that registers, shift registers, processor registers, data buffers, among others, are also embraced herein by the term memory. It is also appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “software” refers to any type of executable instruction, including firmware.

In the present disclosure, various aspects are described with terminology that may pertain to particular communication technologies, e.g. with terminology that may pertain to the PTP or TSN context. It is however understood that the aspects described herein may correspondingly apply to other communication technologies, in which same (e.g., structurally same and/or functionally same) components, structures, operations, logic entities, etc. may be referred to with other terms pertaining to the other communication technologies.

The present disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the examples described herein. For purposes of this disclosure, radio communication technologies may be classified as one of a Short Range radio communication technology or Cellular Wide Area radio communication technology. Short Range radio communication technologies may include Bluetooth®, WLAN (e.g., according to any IEEE 802.11 standard), and other similar radio communication technologies. Exemplary Cellular Wide Area radio communication technologies that the present disclosure may utilize include, but are not limited to: Long Term Evolution (LTE), Long Term Evolution-Advanced (LTE-A), 5th Generation (5G) communication systems, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSDPA Plus (HSDPA+), HSUPA (High-Speed Uplink Packet Access), HSUPA Plus (HSUPA+), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), WITS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), Zigbee, Bluetooth®, Wireless Gigabit Alliance (WiGig) standard, Worldwide Interoperability for Microwave Access (WiMax) (e.g., according to an IEEE 802.16 radio communication standard, e.g., WiMax fixed or WiMax mobile), mmWave standards in general (wireless systems operating at 10-90 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication arrangements such as Intelligent-Transport-Systems, etc. Cellular Wide Area radio communication technologies also include “small cells” of such technologies, such as microcells, femtocells, and picocells. Cellular Wide Area radio communication technologies may be generally referred to herein as “cellular” communication technologies. As used herein, a first radio communication technology may be different from a second radio communication technology if the first and second radio communication technologies are based on different communication standards.

The present disclosure may use such radio communication technologies according to various spectrum management schemes, including, but not limited to, dedicated licensed spectrum, unlicensed spectrum, (licensed) shared spectrum (such as LSA, “Licensed Shared Access,” in 2.3-2.4 GHz, 3.4-3.6 GHz, 3.6-3.8 GHz and further frequencies and SAS, “Spectrum Access System,” in 3.55-3.7 GHz and further frequencies), and may use various spectrum bands including, but not limited to, IMT (International Mobile Telecommunications) spectrum (including 450-470 MHz, 790-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 64-71 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 70.2 GHz-71 GHz band, any band between 65.88 GHz and 71 GHz, bands currently allocated to automotive radar applications such as 76-81 GHz, and future bands including 94-300 GHz and above. Furthermore, aspects described herein can also employ radio communication technologies on a secondary basis on bands such as the TV White Space bands (typically below 790 MHz) where in particular the 400 MHz and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, aspects described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. Aspects described herein can also use radio communication technologies with different Single Carrier or OFDM flavors (CP-OFDM, SC-FDMA, SC-OFDM, filter bank-based multicarrier (FBMC), OFDMA, etc.) and in particular 3GPP NR (New Radio), which can include allocating the OFDM carrier data bit vectors to the corresponding symbol resources.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor may transmit or receive data over a software-level connection with another processor in the form of radio signals, where radio-layer components carry out the physical transmission and reception, such as radio frequency (RF) transceivers and antennas, and the processors perform the logical transmission and reception over the software-level connection.

The term “communicate” encompasses one or both of transmitting and receiving, i.e., unidirectional or bidirectional communication in one or both of the incoming and outgoing directions. In general, the term “communicate” may include the exchange of data, e.g., unidirectional or bidirectional exchange in one or both of the incoming and outgoing directions.

The term “calculate” encompasses both ‘direct’ calculations via a mathematical expression/formula/relationship and ‘indirect’ calculations via lookup or hash tables and other array indexing or searching operations.

As utilized herein, the term “derived from” designates being obtained directly or indirectly from a specific source. Accordingly, data derived from a source includes data obtained directly from the source or indirectly from the source, i.e. through one or more secondary agents.

The word “exemplary” is used herein to mean “serving as an example, instance, or illustration”. Any embodiment or design described herein as “exemplary” is not necessarily to be construed as preferred or advantageous over other embodiments or designs.

The words “plural” and “multiple” in the description and the claims, if any, are used to expressly refer to a quantity greater than one. Accordingly, any phrases explicitly invoking the aforementioned words (e.g. “a plurality of [objects]”, “multiple [objects]”) referring to a quantity of objects is intended to expressly refer more than one of the said objects. For instance, the phrase “a plurality” may be understood to include a numerical quantity greater than or equal to two (e.g., two, three, four, five, [ . . . ], etc.). The terms “group”, “set”, “collection”, “series”, “sequence”, “grouping”, “selection”, etc., and the like in the description and in the claims, if any, are used to refer to a quantity equal to or greater than one, i.e. one or more. Accordingly, the phrases “a group of [objects]”, “a set of [objects]”, “a collection of [objects]”, “a series of [objects]”, “a sequence of [objects]”, “a grouping of [objects]”, “a selection of [objects]”, “[object] group”, “[object] set”, “[object] collection”, “[object] series”, “[object] sequence”, “[object] grouping”, “[object] selection”, etc., used herein in relation to a quantity of objects is intended to refer to a quantity of one or more of said objects. It is appreciated that unless directly referred to with an explicitly stated plural quantity (e.g. “two [objects]”, “three of the [objects]”, “ten or more [objects]”, “at least four [objects]”, etc.) or express use of the words “plural”, “multiple”, or similar phrases, references to quantities of objects are intended to refer to one or more of said objects.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

As used herein, a signal (e.g., data) that is “indicative of” or “representative of” a value or other information may be a digital or analog signal that encodes or otherwise communicates the value or other information in a manner that can be decoded by and/or cause a responsive action in a component receiving the signal. The signal may be stored or buffered in computer readable storage medium prior to its receipt by the receiving component and the receiving component may retrieve the signal from the storage medium. Further, a “value” that is “indicative of” or “representative of” some quantity, state, or parameter may be physically embodied as a digital signal, an analog signal, or stored bits that encode or otherwise communicate the value.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A device comprising a processor coupled to storage, wherein the processor is configured to:
detect a failed reception, at a follower device, of time synchronization information providing an update of a clock of the follower device for synchronization to a clock of a leader device;
determine whether a clock drift between the clock of the follower device and the clock of the leader device is less than a predefined drift threshold; and
in the case that the clock drift is less than the predefined drift threshold, instruct an update of the clock of the follower device based on time synchronization information previously received at the follower device.

2. The device according to claim 1,
wherein the update of the clock of the follower device for synchronization to the clock of the leader device comprises an update of a clock value of the clock of the follower device for synchronization to a clock value of the clock of the leader device and/or an update of a clock rate of the clock of the follower device for synchronization to a clock rate of the clock of the leader device.

3. The device according to claim 1,
wherein the processor is configured to detect the failed reception of time synchronization information by detecting a failed reception of a time synchronization packet at the follower device.

4. The device according to claim 3,
wherein the time synchronization packet is or comprises a generic Precision Time Protocol packet.

5. The device according to claim 1,
wherein the clock drift between the clock of the follower device and the clock of the leader device comprises a drift of a clock value of the clock of the follower device with respect to a clock value of the clock of the leader device and/or a drift of a clock rate of the clock of the follower device with respect to a clock rate of the clock of the leader device.

6. The device according to claim 1,
wherein the processor is configured to detect the failed reception of time synchronization information at the follower device by determining that a time synchronization interval has elapsed without the follower device receiving time synchronization information during the time synchronization interval.

7. The device according to claim 1,
wherein the processor is configured to determine whether the clock drift between the clock of the follower device and the clock of the leader device is less than the predefined drift threshold by:
determining a plurality of drift values each corresponding to previous time synchronization information received at the follower device prior to the failed reception of the time synchronization information,
wherein each drift value is representative of a difference between a clock value of the clock of the follower device and a clock value of the clock of the leader device prior to the update instructed by the corresponding time synchronization information; and
determining whether the clock drift between the clock of the follower device and the clock of the leader device is less than the predefined drift threshold based on the plurality of drift values.

8. The device according to claim 7,
wherein the processor is configured to determine that the clock drift between the clock of the follower device and the clock of the leader device is less than the predefined drift threshold in the case that each drift value is less than the predefined drift threshold.

9. The device according to claim 7,
wherein each drift value comprises the root mean square of the clock value of the clock of the follower device and the clock value of the clock of the leader device prior to the corresponding update.

10. The device according to claim 9,
wherein the processor is configured to determine that the clock drift between the clock of the follower device and the clock of the leader device is less than the predefined drift threshold in the case that each root mean square is a single digit number.

11. The device according to claim 7,
wherein the plurality of drift values comprises an exponential average with a suitably tuned alpha parameter.

12. The device according to claim 1,
wherein to instruct the update of the clock of the follower device based on time synchronization information previously received at the follower device the processor is configured to:
determine a plurality of update values each corresponding to previous time synchronization information received at the follower device prior to the failed reception of the time synchronization information,
wherein each update value is representative of an update of the clock value of the clock of the follower device instructed by the corresponding time synchronization information and/or of an update of the clock rate of the clock of the follower device instructed by the corresponding time synchronization information; and
define an update value for updating the clock value and/or the clock rate of the clock of the follower device based on the plurality of update values.

13. The device according to claim 12,
wherein the processor is further configured to use the defined update value to update the clock value and/or the clock rate of the clock of the follower device.

14. The device according to claim 12,
wherein the processor is configured to define the update value for updating the clock value and/or the clock rate of the clock of the follower device by extrapolating the update value from the plurality of update values.

15. The device according to claim 1,
wherein the processor is further configured to:
instruct the follower device to process control information using the updated clock of the follower device.

16. The device according to claim 1,
wherein the follower device and the leader device are Time Sensitive Networking-enabled devices.

17. A device comprising a processor coupled to storage, wherein the processor is configured to:
instruct an update of a clock of a follower device to continue processing time-critical control information at the follower device in absence of time synchronization information from a leader device by using time synchronization information previously received at the follower device.

18. The device according to claim 17,
wherein the follower device and the leader device are Time Sensitive Networking-enabled devices.

19. A device comprising a processor coupled to storage, wherein the processor is configured to:
determine if a time synchronization at a follower device fails,
wherein the time synchronization causes an update of a clock value of a clock of the follower device for synchronization to a further clock of another device;
if it is determined that the time synchronization fails, determine whether a drift between the clock and the further clock is less than a predefined drift threshold; and
if it is determined that the drift is less than the predefined drift threshold, update the clock value of the clock using time synchronization information previously received at the follower device.

20. The device according to claim 19,
wherein the processor is configured to detect the failed time synchronization by detecting a failed reception of a time synchronization packet at the follower device.
